(19) United States
(12) Patent Application Publication
(10) Pub. No.: US 2022/0407422 A1
(43) Pub. Date: Dec. 22, 2022

(54) COT PARALLEL CIRCUIT AND POWER SUPPLY DEVICE

(71) Applicant: HUAWEI TECHNOLOGIES CO., LTD., Shenzhen (CN)

(72) Inventors: Junliang QIN, Dongguan (CN); Zhiqiang XIANG, Dongguan (CN)

(73) Assignee: HUAWEI TECHNOLOGIES CO., LTD., Shenzhen (CN)

(21) Appl. No.: 17/843,213

(22) Filed: Jun. 17, 2022

(30) Foreign Application Priority Data
Jun. 18, 2021 (CN) 202110679948.4

(51) Int. Cl. H02M 3/158; H02M 7/493; H02J 1/10

(52) U.S. Cl. CPC H02M 3/1584; H02M 7/493; H02J 1/102

(57) ABSTRACT

This application provides a COT parallel circuit and a power supply device. After receiving a first power signal output by a first phase converter, the COT multiphase parallel circuit may output a first pulse signal to a second phase converter, where the first pulse signal is used to indicate to the second phase converter to output a second power signal. Further, the COT multiphase parallel circuit may output a plurality of power signals in one period of a RAMP signal. A high-frequency power signal can be output without increasing a frequency of the RAMP signal, thereby reducing the difficulty of implementing a high-frequency COT multiphase parallel connection.

### CROSS-REFERENCE TO RELATED APPLICATION

This application claims priority to Chinese Patent Application No. 202110679948.4, filed on Jun. 18, 2021, which is hereby incorporated by reference in its entirety.

### TECHNICAL FIELD

Embodiments of this application relate to the field of circuit, and in particular, to a constant on time (COT) control parallel circuit and a power supply device.

### BACKGROUND

With improvements in the integration of electronic products, an embedded high-performance circuit system requires that the output voltage of a power supply be able to quickly respond to load jumps while the power supply device outputs a high current. COT can quickly respond to the load jump and keep the output voltage stable to meet a load jump requirement. A current output capability of the power supply device can be improved through multi-COT parallel connections.

Currently, when outputting a signal, a COT multiphase parallel circuit first needs to construct a continuous RAMP signal. A controller included in the COT multiphase parallel circuit may generate a pulse signal based on a period of each RAMP signal. Switch assemblies that receive the pulse signal output power signals in sequence. As a frequency of an output power signal of a switch assembly is increased, a frequency of a constructed continuous RAMP signal also needs to be increased accordingly. For example, if an operating frequency of a single switch assembly is 8 MHz, a frequency of a continuous RAMP signal is 32 MHz for a 4-phase COT parallel circuit, and a frequency of a continuous RAMP is 48 MHz for a 6-phase COT parallel circuit. When the operating frequency of the switch assembly is increased, the frequency of the continuous RAMP also needs to be increased accordingly.

The continuous RAMP is usually generated by a signal generator. However, a signal generator produced by using a BCD process has an inherent delay, and consequently, has a relatively high difficulty in constructing a high-frequency RAMP signal and is unable to generate a higher-frequency continuous RAMP. This limits a frequency of an output power signal of the COT multiphase parallel circuit, that is, limits a frequency of an output power signal of the power supply device.

### SUMMARY

This application provides a COT parallel circuit and a power supply device, to reduce the difficulty of implementing a high-frequency COT multiphase parallel connection.

A first aspect of this application provides a constant on time (COT) control parallel circuit, including a first phase converter, a second phase converter, a multiphase controller, and a filter module. An output terminal of the first phase converter is electrically connected to an input terminal of the multiphase controller and a first input terminal of the filter module. An input terminal of the second phase converter is electrically connected to an output terminal of the multiphase controller, and an output terminal of the second phase converter is electrically connected to a second input terminal of the filter module. The multiphase controller is configured to control, in one period of a RAMP signal received by the COT parallel circuit and based on a first power signal output by the first phase converter, the second phase converter to output a second power signal.

In this application, after receiving the first power signal output by the first phase converter, the COT multiphase parallel circuit included in a power supply device may output a first pulse signal to the second phase converter, where the first pulse signal is used to indicate to the second phase converter to output the second power signal. Further, the COT multiphase parallel circuit may output a plurality of power signals in one period of a RAMP signal. A high-frequency power signal can be output without increasing a frequency of the RAMP signal, thereby reducing the difficulty of implementing a high-frequency COT multiphase parallel connection.

In a possible implementation of the first aspect, the multiphase controller includes a frequency divider, a first phase inverter, a first period control module, a second period control module, and a first OR gate. An input terminal of the frequency divider is electrically connected to the output terminal of the first phase converter, and an output terminal of the frequency divider is electrically connected to an input terminal of the first period control module and an input terminal of the first phase inverter through a first connection point. An output terminal of the first phase inverter is electrically connected to an input terminal of the second period control module. An input terminal of the first OR gate is electrically connected to an output terminal of the first period control module and an output terminal of the second period control module. The first period control module and the second period control module are configured to: collect, by using a time collection circuit including a plurality of capacitors and a plurality of constant current sources, an output period of the first power signal output by the first phase converter, and output a target signal based on the output period. The first OR gate is configured to output a first pulse signal based on the target signal output by the first period control module or the second period control module, where the first pulse signal is used to indicate to the second phase converter to output the second power signal.

In this possible implementation, the multiphase controller collects the output period of the first power signal by using the first period module and the second period module, plans an output time of the target signal based on the output period of the first power signal, and further outputs the target signal. The first OR gate outputs the first pulse signal based on the target signal output by the first period control module or the second period control module. This possible implementation provides a specific implementation of controlling, by the multiphase controller based on the first power signal, the second phase converter to output the second power signal, thereby improving the implementability of the solution.

In a possible implementation of the first aspect, the first period control module includes a second phase inverter, a constant current source module, a first switch module, a second switch module, a capacitor module, and a first comparator. The capacitor module includes a first capacitor and a second capacitor. A first terminal of the second phase inverter is electrically connected to the output terminal of the frequency divider, and a second terminal of the second phase inverter is electrically connected to a first terminal of the second switch module. A first terminal of the first switch module is electrically connected to the output terminal of the frequency divider, a second terminal of the first switch module is electrically connected to a first terminal of the constant current source module, and a third terminal of the first switch module is electrically connected to a first terminal of the capacitor module. A second terminal of the second switch module is electrically connected to a second terminal of the constant current source module, and a third terminal of the second switch module is grounded. A third terminal of the capacitor module is grounded. A negative input terminal of the first comparator is electrically connected to the first switch module and the first capacitor through a second connection point, and a positive input terminal of the first comparator is electrically connected to the first switch module and the second capacitor through a third connection point. The first switch module is configured to control, based on different signals output by the frequency divider, a charging time of the first capacitor and the second capacitor in the capacitor module by the constant current source module, where the charging time of the first capacitor and the second capacitor in the capacitor module by the constant current source module is the same as the output period of the first power signal. The second switch module is configured to control, based on a signal output by the second phase inverter, the first capacitor to discharge. The first comparator is configured to: when the first capacitor discharges, output the target signal when determining that a voltage value of the first capacitor is less than a voltage value of the second capacitor.

In this possible implementation, the first switch module may control, based on different signals output by the frequency divider, the charging time of the first capacitor and the second capacitor in the capacitor module by the constant current source module. When the frequency divider outputs a high-level signal, the first switch module receives the high-level signal, and controls a switch to be closed, so that the constant current source module may charge the first capacitor and the second capacitor through the closed switch, where the charging time is the same as the period of the first power signal output by the first phase converter. In this way, the first switch module completes the collection of the period of the first power signal. When the frequency divider outputs a low-level signal, the first switch module receives the low-level signal, and controls the switch to be open, so that the constant current source module stops charging the first switch module. The second phase inverter receives the low-level signal output by the frequency divider, converts the low-level signal into a high-level signal, and outputs the high-level signal to the second switch module. After receiving the high-level signal, the second switch module controls a switch between the constant current source module and a ground cable to be closed, so that the first capacitor can slowly discharge through the constant current source module. The negative input terminal of the first comparator collects a voltage of the first capacitor, and the positive input terminal of the first comparator collects a voltage of the second capacitor. When the first capacitor slowly discharges until the voltage is less than the voltage of the second capacitor, the first comparator is inverted, and outputs the target signal to the first OR gate. The target signal may enable the first OR gate to output the first pulse signal. This possible implementation provides a specific implementation of the multiphase controller, thereby improving implementability of the solution.

In a possible implementation of the first aspect, the first period control module further includes a first flip-flop. A first input terminal of the first flip-flop is electrically connected to the first comparator, a second input terminal of the first flip-flop is electrically connected to the frequency divider, and an output terminal of the first flip-flop is electrically connected to the second switch module. The first flip-flop is configured to control, based on electrical signals output by the first comparator and the frequency divider, some switches in the second switch module to be closed. The second switch module is further configured to control, by closing some switches and based on a signal output by the first flip-flop, the first capacitor and the second capacitor to empty charges.

In this possible implementation, after receiving a signal output by the frequency divider, the first flip-flop outputs a low-level signal to the second switch module, and a switch between the first capacitor and the ground cable and a switch between the second capacitor and the ground cable in the second switch module are open. If the first flip-flop receives the target signal output by the first comparator, the first flip-flop controls the switch between the first capacitor and the ground cable and the switch between the second capacitor and the ground cable in the second switch module to be closed. Further, the second switch module controls, based on the signal output by the first flip-flop, the first capacitor and the second capacitor to be connected to the ground cable, to empty charges, so that the first capacitor and the second capacitor can continue to be charged and discharge in a next operating period to operate properly.

In a possible implementation of the first aspect, the constant current source module includes a first constant current source, a second constant current source, and a third constant current source, the first switch module includes a first switch and a second switch, and the second switch module includes a third switch, a fourth switch, and a fifth switch. First terminals of the first switch and the second switch are electrically connected to the output terminal of the frequency divider, a second terminal of the first switch is electrically connected to a first terminal of the first constant current source, a third terminal of the first switch is electrically connected to a first terminal of the first capacitor, a second terminal of the second switch is electrically connected to a first terminal of the second constant current source, and a third terminal of the second switch is electrically connected to a first terminal of the second capacitor. A first terminal of the third switch is electrically connected to the second phase inverter, a second terminal of the third switch is electrically connected to the third constant current source, a third terminal of the third switch is grounded, a first terminal of the fourth switch is electrically connected to the first terminal of the first capacitor and the third terminal of the first switch through a fourth connection point, a second terminal of the fourth switch is electrically connected to the output terminal of the first flip-flop, a third terminal of the fourth switch is grounded, a first terminal of the fifth switch is electrically connected to the first terminal of the second capacitor and the third terminal of the second switch through a fifth connection point, a second terminal of the fifth switch is electrically connected to the output terminal of the first flip-flop, and a third terminal of the fifth switch is grounded. Second terminals of the first constant current source and the second constant current source are electrically connected to an external power supply.

This possible implementation provides a specific implementation and a specific connection relationship of the constant current source module, the first switch module, the second switch module, and the capacitor module that are included in the multiphase controller, thereby improving implementability of the solution.

In a possible implementation of the first aspect, the COT parallel circuit further includes a signal processing module, where

an input terminal of the signal processing module is electrically connected to an output terminal of the filter module, an output terminal of the signal processing module is electrically connected to an input terminal of the first phase converter, and the signal processing module is configured to output a second pulse signal based on the received RAMP signal and a signal output by the filter module, where the second pulse signal is used to indicate to the first phase converter to output the first power signal.

In this possible implementation, the COT parallel circuit further includes the signal processing module. The signal processing module may receive the RAMP signal and the signal output by the filter module, and output the second pulse signal when a value of the RAMP signal is less than a value of the signal output by the filter module, where the second pulse signal may indicate to the first phase converter to output the first power signal. This possible implementation provides a specific control method for controlling the first phase converter to output the first power signal, thereby improving implementability of the solution.

In a possible implementation of the first aspect, the signal processing module includes a first operational amplifier and a second comparator. A first reference signal is input to a first input terminal of the first operational amplifier, a second input terminal of the first operational amplifier is electrically connected to the output terminal of the filter module, and an output terminal of the first operational amplifier is electrically connected to a first input terminal of the second comparator. The ramp compensation RAMP signal is input to a second input terminal of the second comparator, and an output terminal of the second comparator is electrically connected to the input terminal of the first phase converter. The first operational amplifier is configured to adjust, based on the first reference signal and the signal output by the filter module, a value of a signal output to the second comparator. The second comparator is configured to output the first pulse signal when determining that a value of the RAMP signal is less than the value of the signal output by the first operational amplifier.

In this possible implementation, the first operational amplifier is configured to adjust, by using a feedback, a frequency of a pulse signal output by the second comparator. The first reference signal is used to adjust a magnitude of a signal EAO. If a value of the first reference signal is greater than that of a power signal output by the filter module, the first operational amplifier increases a value of the output signal EAO, and a frequency of the pulse signal output by the second comparator is increased. Similarly, if the value of the first reference signal is less than that of the power signal output by the filter module, the first operational amplifier reduces the value of the output signal EAO, and the frequency of the pulse signal output by the second comparator is reduced. Further, the frequency of the pulse signal output by the second comparator may be adjusted by adjusting a reference voltage, to further control the intensity of an output current of the entire COT parallel circuit.

In this possible implementation, the first phase converter includes a first on timer, a first drive circuit, a sixth switch, and a seventh switch. A first input terminal of the first on timer is electrically connected to the output terminal of the signal processing module, a second input terminal of the first on timer is electrically connected to a second input terminal of the second phase converter, and an output terminal of the first on timer is electrically connected to an input terminal of the first drive circuit. A first output terminal of the first drive circuit is electrically connected to a first terminal of the sixth switch, and a second output terminal of the first drive circuit is electrically connected to a first terminal of the seventh switch. A second terminal of the sixth switch is electrically connected to the external power supply, and a third terminal of the sixth switch is electrically connected to the second input terminal of the first on timer, a second terminal of the seventh switch, and the first input terminal of the filter module. The second terminal of the seventh switch is electrically connected to the first input terminal of the filter module, and a third terminal of the seventh switch is grounded. The first on timer is configured to output a first signal and a second signal based on the second pulse signal output by the signal processing module and a signal output by the sixth switch, where the first signal is used to indicate to the first drive circuit to close the sixth switch and open the seventh switch, the external power supply in the first phase converter outputs the first power signal through the sixth switch in a closed state, the second signal is used to indicate to the first drive circuit to close the seventh switch and open the sixth switch, and the first phase converter stops outputting the first power signal.

In this possible implementation, the signal processing module outputs a pulse signal to the first on timer based on the power signal output by the filter module and the received RAMP signal. The first on timer outputs a control signal based on the pulse signal and a current output by a VCC through the sixth switch. A high-level signal in the control signal may control the first drive module to close the sixth switch, so that the external power supply VCC connected to the sixth switch inputs a current to the filter module, that is, the first phase converter outputs the first power signal. A low-level signal in the control signal may control the first drive module to open the sixth switch and close the seventh switch. This possible implementation provides a specific structure of the first phase converter, thereby improving implementability of the solution.

In a possible implementation of the first aspect, the second phase converter includes a second on timer, a second drive circuit, an eighth switch, and a ninth switch. A first input terminal of the second on timer is electrically connected to the output terminal of the multiphase controller, a second input terminal of the second on timer is electrically connected to a second input terminal of the first phase converter, and an output terminal of the second on timer is electrically connected to an input terminal of the second drive circuit. A first output terminal of the second drive circuit is electrically connected to a first terminal of the eighth switch, and a second output terminal of the second drive circuit is electrically connected to a first terminal of the ninth switch. A second terminal of the eighth switch is electrically connected to the external power supply, a third terminal of the eighth switch is electrically connected to the second input terminal of the second on timer, a second terminal of the ninth switch, and the second input terminal of the filter module. The second terminal of the ninth switch is electrically connected to the second input terminal of the filter module, and a third terminal of the ninth switch is grounded. The second conduction delay timing circuit is configured to output a third signal and a fourth signal based on the first pulse signal output by the multiphase controller and a signal output by the eighth switch, where the third signal is used to indicate to the second drive circuit to close the eighth switch and open the ninth switch, the external power supply in the second phase converter outputs the second power signal through the eighth switch in a closed state, the fourth signal is used to indicate to the second drive circuit to close the ninth switch and open the eighth switch, and the second phase converter stops outputting the second power signal.

In this possible implementation, the multiphase controller receives the first power signal and outputs the first pulse signal to the second on timer. The second on timer outputs a control signal based on the pulse signal and a current output by the VCC through the eighth switch. A high-level signal in the control signal may control the second drive module to close the eighth switch, so that the external power supply VCC connected to the eighth switch inputs a current to the filter module, that is, the second phase converter outputs the second power signal. A low-level signal in the control signal may control the second drive module to open the eighth switch and close the ninth switch. This possible implementation provides a specific structure of the second phase converter, thereby improving implementability of the solution.

In a possible implementation of the first aspect, the first on timer includes a third switch module, a fourth capacitor, a third comparator, and a third flip-flop. A first terminal of the third switch module is electrically connected to the first drive circuit, a second terminal of the third switch module is electrically connected to the external power supply, a third terminal of the third switch module is electrically connected to a first terminal of the fourth capacitor, and a fourth terminal of the third switch module is grounded. A second terminal of the fourth capacitor is electrically connected to a positive input terminal of the third comparator, and a third terminal of the fourth capacitor is grounded. An output terminal of the third comparator is electrically connected to a first input terminal of the third flip-flop. A second input terminal of the third flip-flop is electrically connected to the signal processing module, and an output terminal of the third flip-flop is electrically connected to the first drive circuit. The third switch module is configured to control, based on a signal output by the first drive circuit, the external power supply to charge the fourth capacitor. The third comparator is configured to output a fifth signal when determining that a value of a reference signal received by a second input terminal of the third comparator is less than a voltage value of the fourth capacitor. The third flip-flop is configured to output the first signal based on a pulse signal output by the signal processing module, and output the second signal based on the fifth signal.

In a possible implementation of the first aspect, the first on timer further includes a current equalization circuit and a third operational amplifier, the current equalization circuit includes a plurality of RC filters, and there is a common node between some RC filters. A first terminal of the current equalization circuit is electrically connected to the sixth switch and the second phase converter, and an output terminal of the current equalization circuit is electrically connected to the third operational amplifier. The current equalization circuit is configured to: perform averaging on the first power signal and the second power signal that are output by the first phase converter and the second phase converter to obtain an average signal, input a filtered first power signal to a positive input terminal of the third operational amplifier, and input the average signal to a negative input terminal of the third operational amplifier. The third operational amplifier is configured to: after determining that the filtered first power signal is less than the average signal, reduce a value of a reference signal input to a second terminal of the third comparator; or after determining that the first power signal is greater than the average signal, increase the value of the reference signal input to the second terminal of the third comparator.

In this application, the current equalization circuit may perform averaging on the first power signal and the second power signal that are output by the first phase converter and the second phase converter to obtain the average signal. After determining that the first power signal is less than the average signal, the third operational amplifier may reduce the value of the reference signal input to the second terminal of the third comparator, so that a time in which the third comparator is inverted is shorter, and a value of the first power signal is reduced. After determining that the first power signal is greater than the average signal, the third operational amplifier increases the value of the reference signal input to the second terminal of the third comparator, so that a time in which the third comparator is inverted is longer, and the value of the first power signal is increased. The current equalization circuit and the third comparator may adjust a magnitude of a first output power, so that the first output power is stable within an appropriate range.

In a possible implementation of the first aspect, the filter module includes a first inductor, a second inductor, and a third capacitor. A first terminal of the first inductor is electrically connected to the third terminal of the sixth switch and the second terminal of the seventh switch, and a second terminal of the first inductor is electrically connected to a first terminal of the second inductor and a first terminal of the third capacitor. The first terminal of the second inductor is electrically connected to the third terminal of the eighth switch and the second terminal of the ninth switch, and a second terminal of the second inductor is electrically connected to the first terminal of the third capacitor. A second terminal of the third capacitor is grounded. The first inductor, the second inductor, and the third capacitor are jointly configured to filter output ripples of the first power signal and the second power signal.

This possible implementation provides a specific implementation of the filter module, thereby improving implementability of the solution.

A second aspect of embodiments of this application provides a power supply device. The power supply device includes a controller and a COT parallel circuit. The COT parallel circuit outputs a power signal under control of the controller. The COT parallel circuit is the COT parallel circuit described in any one of the first aspect or the possible implementations of the first aspect.

It can be learned from the foregoing technical solutions that embodiments of this application have the following advantages:

In this application, after receiving the first power signal output by the first phase converter, the COT multiphase parallel circuit included in the power supply device may output the first pulse signal to the second phase converter, where the first pulse signal is used to indicate to the second phase converter to output the second power signal. Further, the COT multiphase parallel circuit may output a plurality of power signals in one period of a RAMP signal. A high-frequency power signal can be output without increasing a frequency of the RAMP signal, thereby reducing the difficulty of implementing a high-frequency COT multiphase parallel connection.

### BRIEF DESCRIPTION OF DRAWINGS

FIG. 1 is a schematic diagram of application of a power supply device according to this application;

FIG. 2 is a schematic diagram of a structure of a COT multiphase parallel circuit according to this application;

FIG. 3 is a schematic diagram of another structure of a COT multiphase parallel circuit according to this application;

FIG. 4 is a schematic diagram of application of a COT multiphase parallel circuit according to this application;

FIG. 5a is a schematic diagram of a structure of a multiphase controller according to this application;

FIG. 5b is a schematic diagram of a structure of a first period control module according to this application;

FIG. 5c is a schematic diagram of another structure of a first period control module according to this application;

FIG. 5d is a schematic diagram of another structure of a multiphase controller according to this application;

FIG. 5e is a schematic diagram of another structure of a multiphase controller according to this application;

FIG. 6 is a schematic diagram of another application of a multiphase controller according to this application;

FIG. 7 is a schematic diagram of another structure of a multiphase controller according to this application;

FIG. 8 is a schematic diagram of another structure of a COT multiphase parallel circuit according to this application;

FIG. 9 is a schematic diagram of another structure of a COT multiphase parallel circuit according to this application;

FIG. 10 is a schematic diagram of a structure of a first on timer according to this application;

FIG. 11 is a schematic diagram of another structure of a first on timer according to this application;

FIG. 12 is a schematic diagram of structures of a first on timer and a second on timer according to this application;

FIG. 13 is a schematic diagram of a structure of a current equalization circuit according to this application; and

FIG. 14 is a schematic diagram of another structure of a COT multiphase parallel circuit according to this application.

### DESCRIPTION OF EMBODIMENTS

The following clearly and completely describes technical solutions in embodiments of the present invention with reference to accompanying drawings in the embodiments of the present invention. It is clear that the described embodiments are merely some rather than all of the embodiments of the present invention. All other embodiments obtained by a person skilled in the art based on the embodiments of the present invention shall fall within the protection scope of the present invention.

In the specification, claims, and accompanying drawings of the present invention, the terms “first”, “second”, “third”, “fourth”, and so on (if any) are intended to distinguish between similar objects but do not necessarily indicate a specific order or sequence. It should be understood that data termed in such a way is interchangeable in proper circumstances, so that the embodiments described herein can be implemented in other orders than the order illustrated or described herein. Moreover, the terms “include”, “have” and any other variants mean to cover non-exclusive inclusion. For example, a process, method, system, product, or device that includes a list of steps or units is not necessarily limited to those expressly listed steps or units, but may include other steps or units that are not expressly listed or inherent to the process, method, product, or device.

With improvements in the integration of electronic products, an embedded high-performance circuit system requires that the output voltage of a power supply be able to quickly respond to a load jump while the power supply device outputs a high current. COT can quickly respond to the load jump and keep the output voltage stable to meet a load jump requirement. A current output capability of the power supply device can be improved through multi-COT parallel connections.

Currently, when outputting a signal, a COT multiphase parallel circuit first needs to construct a continuous RAMP signal. A controller included in the COT multiphase parallel circuit may generate a pulse signal based on a period of each RAMP signal. Switch assemblies that receive the pulse signal output power signals in sequence. As a frequency of an output power signal of a switch assembly is increased, a frequency of a constructed continuous RAMP signal also needs to be increased accordingly. For example, if an operating frequency of a single switch assembly is 8 MHz, a frequency of a continuous RAMP signal is 32 MHz for a 4-phase COT parallel circuit, and a frequency of a continuous RAMP is 48 MHz for a 6-phase COT parallel circuit. When the operating frequency of the switch assembly is increased, the frequency of the continuous RAMP also needs to be increased accordingly.

The continuous RAMP is usually generated by a signal generator. However, a signal generator produced by using a BCD process has an inherent delay, and consequently, has relatively high difficulty in constructing a high-frequency RAMP signal and is unable to generate a higher-frequency continuous RAMP. This limits a frequency of an output power signal of the COT multiphase parallel circuit, that is, limits a frequency of an output power signal of the power supply device.

To resolve the foregoing problems that occur during operation of the conventional COT multiphase parallel circuit, this application provides a COT multiphase parallel circuit and a power supply device. After receiving a first power signal output by a first phase converter, the COT multiphase parallel circuit included in the power supply device may output a first pulse signal to a second phase converter, where the first pulse signal is used to indicate to the second phase converter to output a second power signal. Further, the COT multiphase parallel circuit may output a plurality of power signals in one period of a RAMP signal. A high-frequency power signal can be output without increasing a frequency of the RAMP signal, thereby reducing the difficulty of implementing a high-frequency COT multiphase parallel connection.

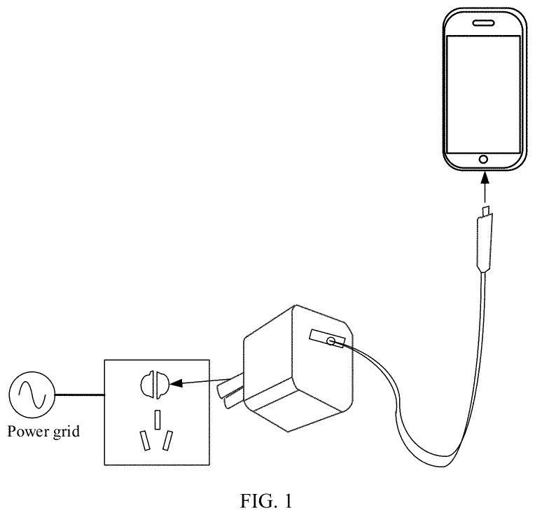

FIG. 1 is a schematic diagram of application of a power supply device according to this application.

As shown in FIG. 1, in this application, a scenario in which a power supply device including a COT multiphase parallel circuit charges a load device may be understood with reference to a mobile phone charging scenario shown in FIG. 1. As shown in FIG. 1, one end of the power supply device is connected to a power grid by using a socket, and the other end of the power supply device is connected to a mobile phone. In this way, a charging loop from the power grid to the mobile phone can be connected, to implement a mobile phone charging process.

The power supply device shown in FIG. 1 is merely a possible form. Actually, there may be a plurality of types of power supply devices. Power supply devices of different types of terminal devices may be different, and power supply devices of a same type of terminal device may also be different. This is not limited in this application.

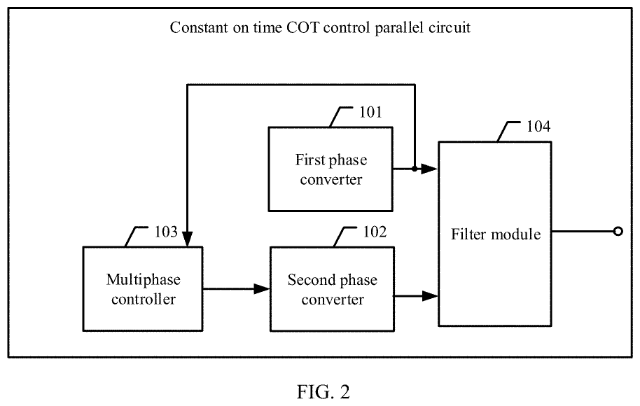

FIG. 2 is a schematic diagram of a structure of a COT multiphase parallel circuit according to this application.

FIG. 2 shows a topology of the COT multiphase parallel circuit provided in this application. The COT multiphase parallel circuit includes a first phase converter 101, a second phase converter 102, a multiphase controller 103, and a filter module 104. An output terminal of the first phase converter 101 is electrically connected to an input terminal of the multiphase controller 103 and a first input terminal of the filter module 104. An input terminal of the second phase converter 102 is electrically connected to an output terminal of the multiphase controller 103, and an output terminal of the second phase converter 102 is electrically connected to a second input terminal of the filter module 104.

In this possible implementation, after receiving a first power signal output by the first phase converter 101, the multiphase controller 103 controls, in one period of a RAMP signal received by the COT parallel circuit and based on a first power signal output by the first phase converter, the second phase converter to output a second power signal. The filter module 104 may filter the first power signal and the second power signal, to reduce output ripples of the first power signal and the second power signal, so that the COT multiphase parallel circuit can output a power signal steadily.

In this application, to improve a current output capability of the COT multiphase parallel circuit, the COT multiphase parallel circuit may further include more phase converters. This possible implementation is described in the following example.

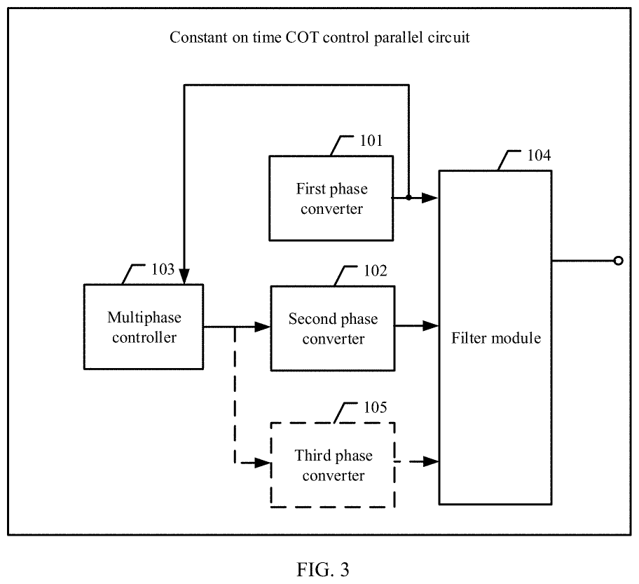

FIG. 3 is a schematic diagram of another structure of a COT multiphase parallel circuit according to this application.

As shown in FIG. 3, in this application, optionally, the COT multiphase parallel circuit may further include a third phase converter 105. An input terminal of the third phase converter 105 is electrically connected to the output terminal of the multiphase controller 103, and an output terminal of the third phase converter 105 is electrically connected to the filter module 104.

In this application, the first phase converter outputs the first power signal to the multiphase controller 103 and the filter module 104. After receiving the first power signal output by the first phase converter 101, the multiphase controller 103 outputs a first pulse signal to the second phase converter 102, where the first pulse signal may trigger the second phase converter 102 to output the second power signal. The multiphase controller 103 outputs a third pulse signal to the third phase converter 105, where the third pulse signal may trigger the third phase converter 105 to output a third power signal. The filter module 104 may filter the first power signal, the second power signal, and the third power signal, to reduce output ripples of the first power signal, the second power signal, and the third power signal, so that the COT multiphase parallel circuit can output a power signal steadily.

In this application, the COT multiphase parallel circuit provided in the embodiment shown in FIG. 3 includes the third phase converter 105, thereby improving the current output capability of the COT multiphase parallel circuit. Optionally, similarly, to improve the current output capability of the COT multiphase parallel circuit, the COT multiphase parallel circuit provided in this application may further include more phase converters, for example, a fourth phase converter, a fifth phase converter, and a sixth phase converter. This is not specifically limited herein.

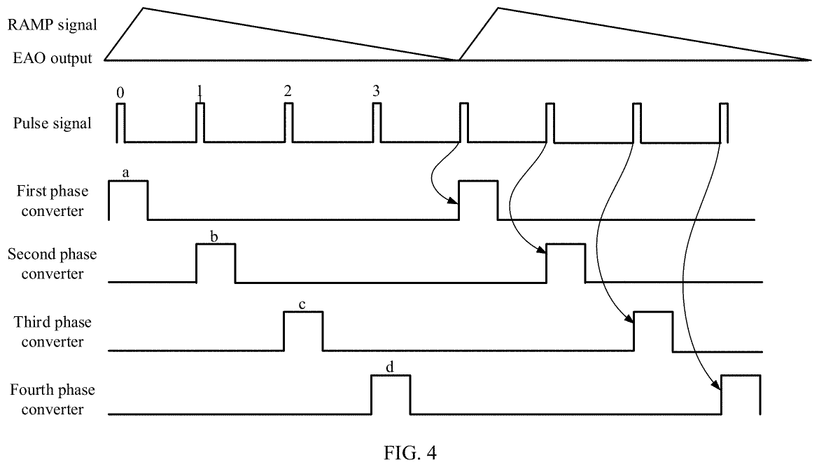

FIG. 4 is a schematic diagram of application of a COT multiphase parallel circuit according to this application.

As shown in FIG. 4, an example in which the COT multiphase parallel circuit includes three phase converters is used to describe methods of sending a power signal and a pulse signal in the COT multiphase parallel circuit. A signal processing module outputs a pulse signal 0 based on a RAMP signal and a power signal a. A first phase converter outputs the power signal a based on a pulse signal 0. A multiphase controller outputs a pulse signal 1 to a second phase converter based on the power signal a. The second phase converter outputs a power signal b based on the pulse signal 1. The multiphase controller outputs a pulse signal 2 to a third phase converter, and the third phase converter outputs a power signal c. The multiphase controller outputs a pulse signal 3 to a fourth phase converter, and the third phase converter outputs a power signal d. When a next period of the RAMP signal arrives, the foregoing signal output process is repeated.

In this application, the COT multiphase parallel circuit may include more or fewer phase converters. When the COT multiphase parallel circuit includes more or fewer phase converters, methods of sending a power signal and a pulse signal are similar to those in the embodiment shown in FIG. 4. Details are not described herein again.

In this application, the multiphase controller 103 described in the embodiments shown in FIG. 2 to FIG. 4 has a specific implementation. The following describes in detail a specific structure included in the multiphase controller 103.

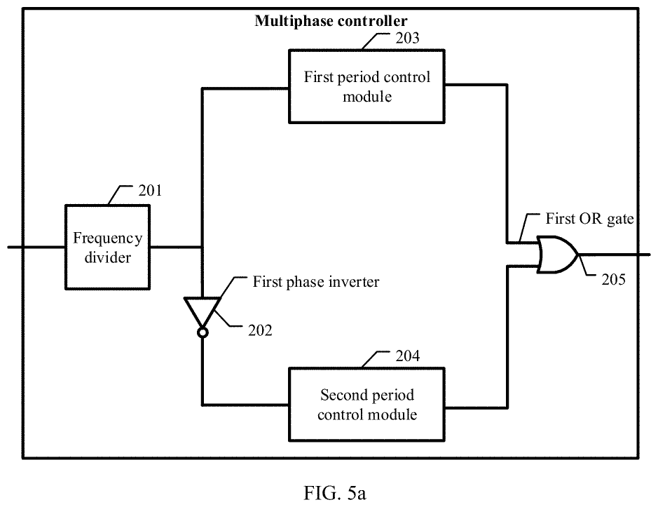

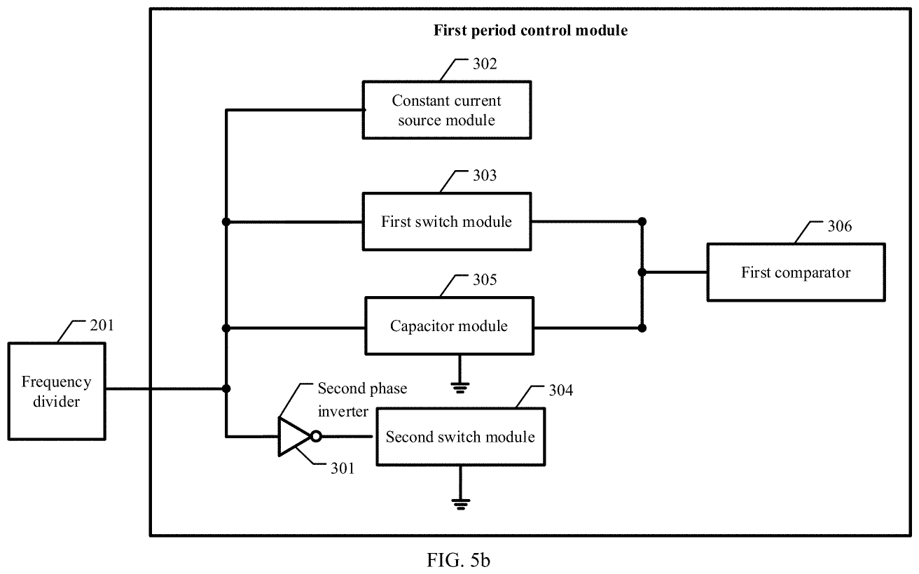

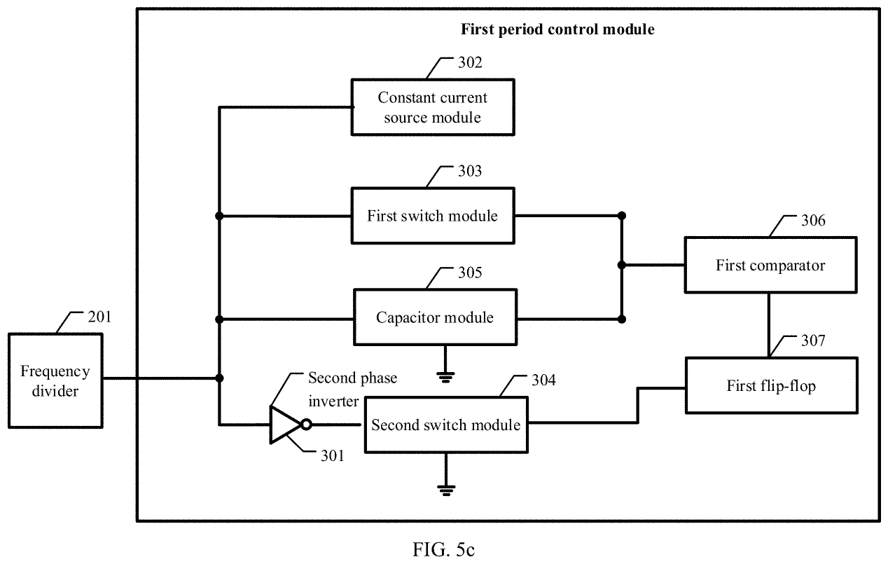

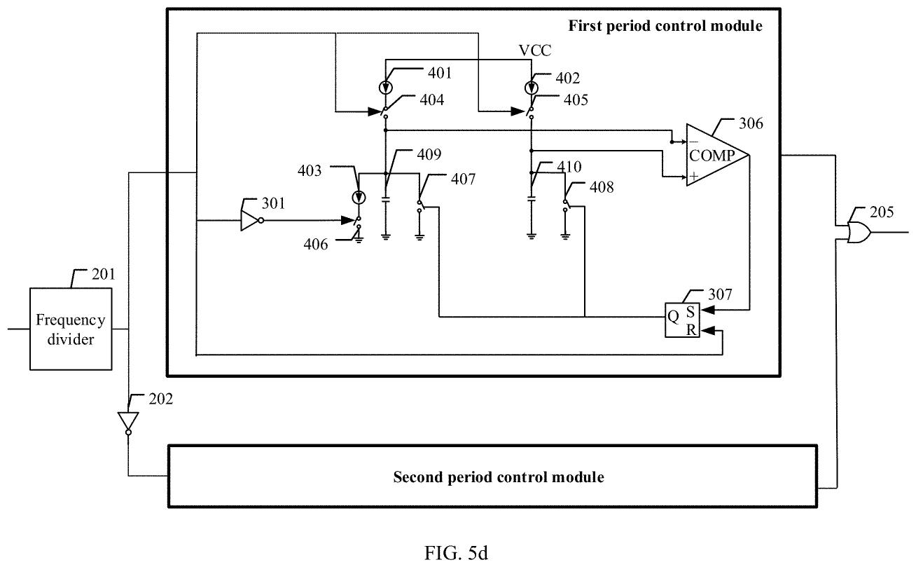

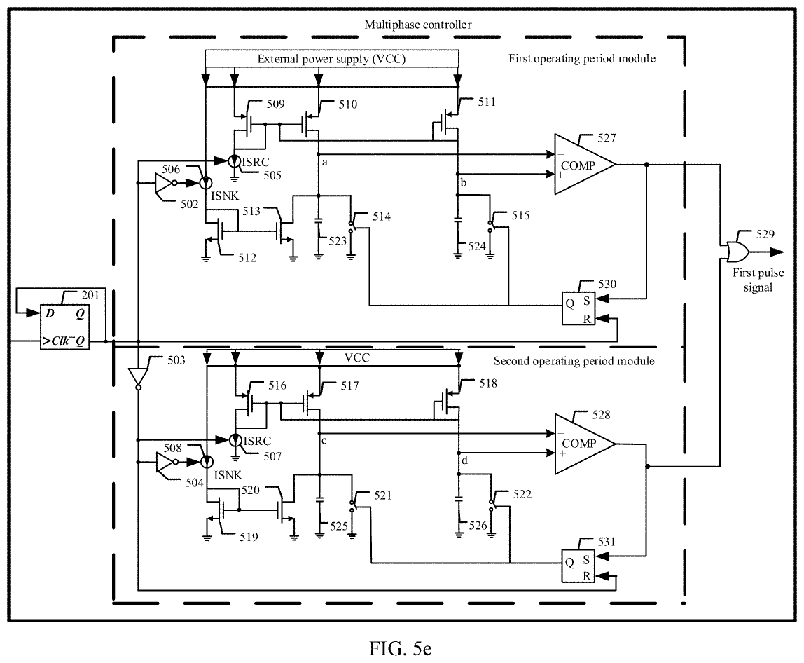

FIG. 5a is a schematic diagram of a structure of a multiphase controller according to this application.

FIG. 5a shows a specific structure of the multiphase controller provided in this application. The multiphase controller includes a frequency divider 201, a first phase inverter 202, a first period control module 203, a second period control module 204, and a first OR gate 205.

An input terminal of the frequency divider 201 is electrically connected to the output terminal of the first phase converter 202, and an output terminal of the frequency divider 201 is electrically connected to an input terminal of the first period control module 204 and an input terminal of the first phase inverter 202 through a first connection point. An output terminal of the first phase inverter 202 is electrically connected to an input terminal of the second period control module 204. An input terminal of the first OR gate 205 is electrically connected to an output terminal of the first period control module 204 and an output terminal of the second period control module 204.

In this application, after receiving different signals output by the frequency divider 201, the first period module 203 and the second period module 204 may collect, by using a time collection circuit including a plurality of capacitors and a plurality of constant current sources, an output period of the first power signal output by the first phase converter, and output a target signal based on the output period. The first OR gate 205 may output the first pulse signal based on the target signal output by the first period control module 203 or the second period control module 204, where the first pulse signal is used to indicate to the second phase converter 102 to output the second power signal.

FIG. 5b is a schematic diagram of a structure of a first period control module according to this application.

FIG. 5b shows the first period control module 203 provided in this application. The first period control module 203 includes a second phase inverter 301, a constant current source module 302, a first switch module 303, a second switch module 304, a capacitor module 305, and a first comparator 306. The capacitor module 305 includes a first capacitor and a second capacitor.

A first terminal of the second phase inverter 301 is electrically connected to the output terminal of the frequency divider 201, and a second terminal of the second phase inverter 301 is electrically connected to a first terminal of the second switch module 304. A first terminal of the first switch module 303 is electrically connected to the output terminal of the frequency divider 201, a second terminal of the first switch module 303 is electrically connected to a first terminal of the constant current source module 302, and a third terminal of the first switch module 303 is electrically connected to a first terminal of the capacitor module 305. A second terminal of the second switch module 304 is electrically connected to a second terminal of the constant current source module 302, and a third terminal of the second switch module 304 is grounded. A third terminal of the capacitor module 305 is grounded. A negative input terminal of the first comparator 306 is electrically connected to the first switch module 303 and the first capacitor through a second connection point, and a positive input terminal of the first comparator is electrically connected to the first switch module 303 and the second capacitor through a third connection point.

In this application, the first switch module 303 may control, based on different signals output by the frequency divider, a charging time of the first capacitor and the second capacitor in the capacitor module 305 by the constant current source module 302. When the frequency divider 201 outputs a high-level signal, the first switch module 303 receives the high-level signal, and controls a switch to be closed, so that the constant current source module 302 may charge the first capacitor and the second capacitor through the closed switch, where the charging time is the same as the period of the first power signal output by the first phase converter 101. In this way, the first switch module 303 completes the collection of the period of the first power signal. When the frequency divider 201 outputs a low-level signal, the first switch module 303 receives the low- level signal, and controls the switch to be open, so that the constant current source module 302 stops charging the first switch module 303. The second phase inverter 301 receives the low-level signal output by the frequency divider 201, converts the low-level signal into a high-level signal, and outputs the high-level signal to the second switch module 304. After receiving the high-level signal, the second switch module 304 controls a switch between the constant current source module 302 and a ground cable to be closed, so that the first capacitor can slowly discharge through the constant current source module 302. The negative input terminal of the first comparator 306 collects a voltage of the first capacitor, and the positive input terminal of the first comparator 306 collects a voltage of the second capacitor. When the first capacitor slowly discharges until the voltage is less than the voltage of the second capacitor, the first comparator 306 is inverted, and outputs the target signal to the first OR gate 205. The target signal may enable the first OR gate 205 to output the first pulse signal.

FIG. 5c is a schematic diagram of another structure of a first period control module according to this application.

As shown in FIG. 5c, optionally, the first period control module further includes a first flip-flop 307. A first input terminal of the first flip-flop 307 is electrically connected to the first comparator 306, a second input terminal of the first flip-flop 307 is electrically connected to the frequency divider 201, and an output terminal of the first flip-flop 307 is electrically connected to the second switch module 304.

In this application, after receiving a signal output by the frequency divider, the first flip-flop 307 outputs a low-level signal to the second switch module, and a switch between the first capacitor and the ground cable and a switch between the second capacitor and the ground cable in the second switch module are open. If the first flip-flop 307 receives the target signal output by the first comparator 306, the first flip-flop controls the switch between the first capacitor and the ground cable and the switch between the second capacitor and the ground cable in the second switch module to be closed. Further, the second switch module 304 controls, based on the signal output by the first flip-flop 307, the first capacitor and the second capacitor to be connected to the ground cable, to empty charges.

FIG. 5d is a schematic diagram of another structure of a multiphase controller according to this application.

As shown in FIG. 5d, optionally, the constant current source module includes a first constant current source 401, a second constant current source 402, and a third constant current source 403, the first switch module includes a first switch 404 and a second switch 405, and the second switch module includes a third switch 406, a fourth switch 407, and a fifth switch 408.

First terminals of the first switch 404 and the second switch 405 are electrically connected to the output terminal of the frequency divider 201. A second terminal of the first switch 404 is electrically connected to a first terminal of the first constant current source 401. A third terminal of the first switch 404 is electrically connected to a first terminal of the first capacitor 409. A second terminal of the second switch 405 is electrically connected to a first terminal of the second constant current source 402. A third terminal of the second switch is electrically connected to a first terminal of the second capacitor.

A first terminal of the third switch 406 is electrically connected to the second phase inverter 202. A second terminal of the third switch 406 is electrically connected to the third constant current source 405. A third terminal of the third switch 406 is grounded. A first terminal of the fourth switch 407 is electrically connected to the first terminal of the first capacitor 409 and the third terminal of the first switch 404 through a fourth connection point. A second terminal of the fourth switch 407 is electrically connected to the output terminal of the first flip-flop 307. A third terminal of the fourth switch 407 is grounded. A first terminal of the fifth switch 408 is electrically connected to the first terminal of the second capacitor 410 and the third terminal of the second switch 405 through a fifth connection point. A second terminal of the fifth switch 408 is electrically connected to the output terminal of the first flip-flop 307. A third terminal of the fifth switch 408 is grounded.

Second terminals of the first constant current source 401 and the second constant current source 402 are electrically connected to an external power supply VCC.

In this application, when the frequency divider 201 outputs a high-level signal, the first switch 404 and the second switch 405 are closed, and the first constant current source 401 and the second constant current source 402 charge the first capacitor 409 and the second capacitor 410 through the first switch 404 in a closed state and the second switch 405 in a closed state. When the frequency divider 201 outputs a low-level signal, the first switch 404 and the second switch 405 are open, and charging of the first capacitor 409 and the second capacitor 410 stops. A charging time is the same as the period of the first power signal output by the first phase converter 101. In this way, the first switch 404 and the second switch 405 complete collecting the period of the first power signal. When the frequency divider 201 outputs a high-level signal, the high-level signal is processed by the second phase inverter 202 and then a low-level signal is output to the third switch 406. The third switch 406, the fourth switch 407, and the fifth switch 408 are all open. When the frequency divider 201 outputs a low-level signal, the low-level signal is processed by the second phase inverter 202 and then a high-level signal is output to the third switch 406. The third switch 406 is closed, and the first capacitor 409 slowly discharges through the third constant current source 403. The negative input terminal of the first comparator 306 collects a voltage of the first capacitor 409, and the positive input terminal of the first comparator 306 collects a voltage of the second capacitor 410. When the first capacitor 409 slowly discharges until the voltage is less than the voltage of the second capacitor 410, the first comparator 306 is inverted, and outputs the target signal to the first OR gate 205. The target signal may enable the first OR gate 205 to output the first pulse signal.

In this application, optionally, the frequency divider 201 may be a D flip-flop, or the frequency divider 201 may be a logic circuit capable of implementing frequency division, or the frequency divider 201 may be another type of frequency divider. This is not specifically limited herein.

In this application, optionally, the first switch to the fifth switch may be triodes, or may be MOS transistors, or may be other types of switches. This is not specifically limited herein.

The multiphase controller provided in this application may include more capacitors, comparators, and OR gates, and further, may output more pulse signals. This is not specifically limited herein.

In this application, an operating principle of the second period control module is similar to that of the first period control module described in the foregoing embodiments. Details are not described herein again.

In this application, to enable the multiphase controller to continuously output pulse signals, the first period control module and the second period control module included in the multiphase controller operate alternately. When the first capacitor and the second capacitor included in the first period control module are in a charging state, the first comparator 306 cannot output a high-level signal. In this case, a capacitor included in the second period control is in a discharging state, and a comparator included in the second period control module may output a high-level signal after being inverted, so that the first OR gate 205 outputs a pulse signal. This ensures that the multiphase controller continuously outputs pulse signals.

FIG. 5e is a schematic diagram of another structure of a multiphase controller according to this application.

FIG. 5e shows a topology of the multiphase controller provided in this application. Optionally, the multiphase controller includes a frequency divider 501, a phase inverter 502, a phase inverter 503, a phase inverter 504, a constant current source 505, a constant current source 506, a constant current source 507, a constant current source 508, a switch 509, a switch 510, a switch 511, a switch 512, a switch 513, a switch 514, a switch 515, a switch 516, a switch 517, a switch 518, a switch 519, a switch 520, a switch 521, a switch 522, a capacitor 523, a capacitor 524, a capacitor 525, a capacitor 526, a comparator 527, a comparator 528, an OR gate 529, a flip-flop 530, and a flip-flop 531.

An input terminal of the frequency divider 501 is electrically connected to an output terminal of the phase converter 101. An output terminal of the frequency divider 501 is electrically connected to a first terminal of the constant current source 505, an input terminal of the phase inverter 502, an input terminal of the phase inverter 503, and a first input terminal of the flip-flop 530 through a first connection point.

A first terminal of the switch 509, a first terminal of the switch 510, and a first terminal of the switch 511 are electrically connected to the external power supply. A second terminal of the switch 509 is electrically connected to a second terminal of the constant current source 505. A second terminal of the switch 510 is electrically connected to a first terminal of the capacitor 523. A second terminal of the switch 511 is electrically connected to a first terminal of the capacitor 524. A third terminal of the switch 509, a third terminal of the switch 510, and a third terminal of the switch 511 are electrically connected to the second terminal of the constant current source 505. A third terminal of the constant current source 505 is grounded. A second terminal of the capacitor 523 is grounded. A second terminal of the capacitor 524 is grounded.

A first terminal of the constant current source 506 is electrically connected to a second terminal of the phase inverter 502. A second terminal of the constant current source 506 is electrically connected to the external power supply. A third terminal of the constant current source 506 is electrically connected to a first terminal of the switch 512, a second terminal of the switch 512, and a first terminal of the switch 513. A third terminal of the switch 512 is grounded. A second terminal of the switch 513 is electrically connected to the first terminal of the first capacitor 523 and the third terminal of the switch 510. A third terminal of the switch 513 is grounded.

A negative input terminal of the comparator 527 is electrically connected to the first terminal of the capacitor 523 and a third terminal of the switch 519 through a second connection point a. A positive input terminal of the comparator 527 is electrically connected to the first terminal of the capacitor 524 and the third terminal of the switch 511 through a third connection point b. An output terminal of the comparator 527 is electrically connected to a first input terminal of the OR gate 529 and a second input terminal of the flip-flop 530.

A first terminal of the switch 514 is electrically connected to the first terminal of the capacitor 523 and the third terminal of the switch 510. A second terminal of the switch 514 is grounded. A third terminal of the switch 514 is electrically connected to an output terminal of the flip-flop 530. A first terminal of the switch 515 is electrically connected to the first terminal of the capacitor 524 and the third terminal of the switch 511. A second terminal of the switch 515 is grounded. A third terminal of the switch 515 is electrically connected to the output terminal of the first flip-flop 530.

A second terminal of the phase inverter 503 is electrically connected to a first terminal of the constant current source 507, a first terminal of the phase inverter 508, and a first input terminal of the second flip-flop 531.

A first terminal of the switch 516, a first terminal of the switch 517, and a first terminal of the switch 518 are electrically connected to the external power supply. A second terminal of the switch 516 is electrically connected to a second terminal of the constant current source 507. A second terminal of the switch 517 is electrically connected to a first terminal of the capacitor 525. A second terminal of the switch 518 is electrically connected to a first terminal of the capacitor 526. A third terminal of the switch 516, a third terminal of the switch 517, and a third terminal of the switch 518 are electrically connected to the second terminal of the constant current source 507. A third terminal of the constant current source 507 is grounded. A second terminal of the capacitor 525 is grounded. A second terminal of the capacitor 526 is grounded.

A first terminal of the constant current source 508 is electrically connected to a second terminal of the phase inverter 504. A second terminal of the constant current source 508 is electrically connected to the external power supply. A third terminal of the constant current source 508 is electrically connected to a first terminal of the switch 519, a second terminal of the switch 519, and a first terminal of the switch 520. A third terminal of the switch 519 is grounded. A second terminal of the switch 520 is electrically connected to the first terminal of the capacitor 525 and the third terminal of the switch 517. A third terminal of the switch 520 is grounded.

A negative input terminal of the comparator 528 is electrically connected to the first terminal of the capacitor 525 and a third terminal of the switch 517 through a fourth connection point c. A positive input terminal of the comparator 528 is electrically connected to the first terminal of the capacitor 526 and the third terminal of the switch 518 through a fifth connection point d. An output terminal of the comparator 528 is electrically connected to a second input terminal of the OR gate 529 and a second input terminal of the flip-flop 531.

A first terminal of the switch 521 is electrically connected to the first terminal of the capacitor 525 and the third terminal of the switch 517. A second terminal of the switch 521 is grounded. A third terminal of the switch 521 is electrically connected to an output terminal of the flip-flop 531. A first terminal of the switch 522 is electrically connected to the first terminal of the capacitor 526 and the third terminal of the switch 518. A second terminal of the switch 522 is grounded. A third terminal of the switch 522 is electrically connected to the output terminal of the second flip-flop 531.

In this application, after receiving the first power signal sent by the phase converter, the frequency divider 501 outputs a high-level signal, and the first period control module included in the multiphase controller is in an energy storage state. When a high level is input to the constant current source 505, the constant current source 505 controls the switch 509, the switch 510, and the switch 511 to be closed, that is, the external power supply VCC charges the capacitor 523 and the capacitor 524. After the frequency divider 501 outputs a low-level signal, the constant current source 505 controls the switch 509, the switch 510, and the switch 511 to be open, and the external power supply VCC stops charging the capacitor 523 and the capacitor 524. The low-level signal output by the frequency divider 501 is processed by the phase inverter 502 and then a high-level signal is output. The constant current source 506 controls the switch 512 and the switch 513 to be closed, and the capacitor 523 slowly discharges through the switch 523. A negative input terminal of the comparator 527 collects a voltage of the capacitor 523, and a positive input terminal of the comparator collects a voltage of the capacitor 524. When the voltage of the capacitor 523 is lower than the voltage of the capacitor 524 after the discharging, the comparator 527 is inverted and outputs a high-level signal to the OR gate 529, and the OR gate 529 outputs the first pulse signal to the phase converter. Further, the second phase converter may be controlled by the first pulse signal to output the second power signal. The comparator 527 outputs a high-level signal to the flip-flop 530. In this case, the flip-flop 530 outputs an electrical signal to control the switch 514 and the switch 515 to be closed, so that the capacitor 523 and the capacitor 524 can discharge through the switch 514 and the switch 515.

In this application, to enable the multiphase controller to continuously output pulse signals, the first period control module and the second period control module included in the multiphase controller operate alternately. When the first capacitor and the second capacitor included in the first period control module are in a charging state, the comparator 527 cannot output a high-level signal. In this case, a third capacitor and a fourth capacitor that are included in the second period control are in a discharging state, and the comparator 528 may output a high-level signal after being inverted, so that the OR gate 529 outputs a pulse signal. This ensures that the multiphase controller continuously outputs pulse signals.

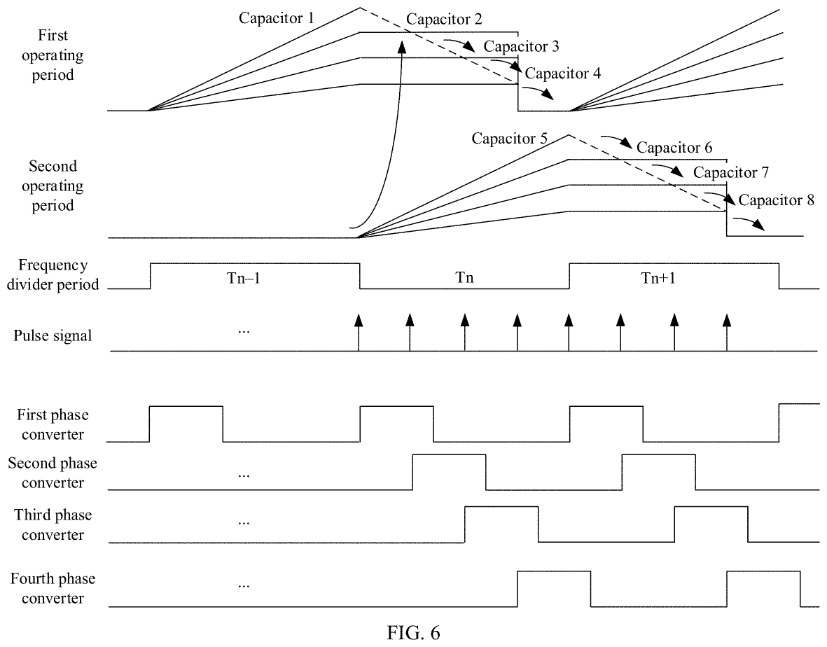

FIG. 6 is a schematic diagram of application of a multiphase controller according to this application.

As shown in FIG. 6, an example in which the multiphase controller includes eight capacitors is used to describe a process of outputting a pulse signal by the multiphase controller. It is assumed that a first period control module of the multiphase controller includes a capacitor 1, a capacitor 2, a capacitor 3, and a capacitor 4, and a second period control module of the multiphase controller includes a capacitor 5, a capacitor 6, a capacitor 7, and a capacitor 8.

As shown in FIG. 6, the first period control is used as an example for description. After a COT parallel circuit outputs a first power signal, a frequency divider outputs a high-level signal after receiving the first power signal. The capacitor 1, the capacitor 2, the capacitor 3, and the capacitor 4 start to be charged. After a first phase converter outputs a first power signal again, the frequency divider outputs a low-level signal after receiving the first power signal. The capacitor 1 starts to discharge, and voltages of the capacitor 2, the capacitor 3, and the capacitor 4 remain unchanged. When a voltage of the capacitor 1 is lower than a voltage of the capacitor 2, a corresponding comparator 1 that collects the voltages of the capacitor 1 and the capacitor 2 is inverted, the comparator 1 outputs a high-level signal (a target signal), and an OR gate 1 connected to the comparator 1 outputs a first pulse signal. Correspondingly, a second phase converter outputs a second power signal. Similarly, when the voltage of the capacitor 1 is lower than each of a voltage of the capacitor 3 and a voltage of the capacitor 4, a corresponding comparator 2 and comparator 3 that collect the voltages of the capacitor 3 and the capacitor 4 are inverted, the comparator 2 and the comparator 3 output high-level signals (target signals), and an OR gate 2 and an OR gate 3 that are connected to the comparator 2 and the comparator 3 output a third pulse signal and a fourth pulse signal. Correspondingly, a third phase converter and a fourth phase converter output a third power signal and a fourth power signal respectively. In addition, after the frequency divider outputs the low-level signal after receiving the first power signal, the capacitor 5 in the second period control module is triggered to discharge, so that the multiphase controller can continuously output pulse signals when the first period control module is charged.

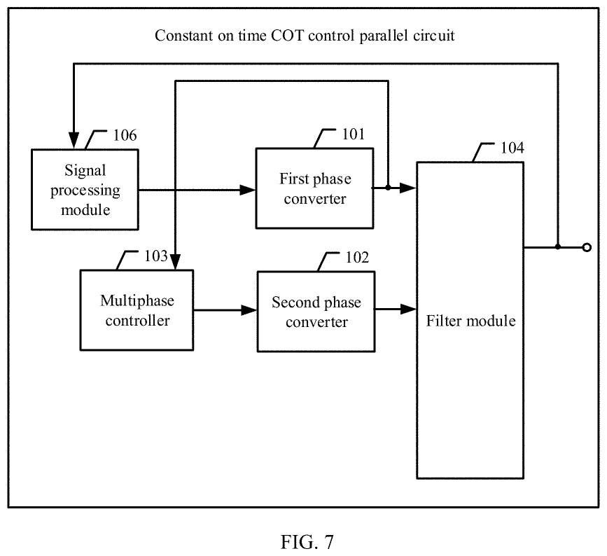

FIG. 7 is a schematic diagram of another structure of a COT parallel circuit according to this application.

As shown in FIG. 7, in this application, the COT parallel circuit further includes a signal processing module 106. An input terminal of the signal processing module 106 is electrically connected to an output terminal of the filter module 104, and an output terminal of the signal processing module 106 is electrically connected to an input terminal of the first phase converter 101.

In this application, the signal processing module 106 may output a second pulse signal based on a received RAMP signal and a signal output by the filter module, where the second pulse signal is used to indicate to the first phase converter to output the first power signal.

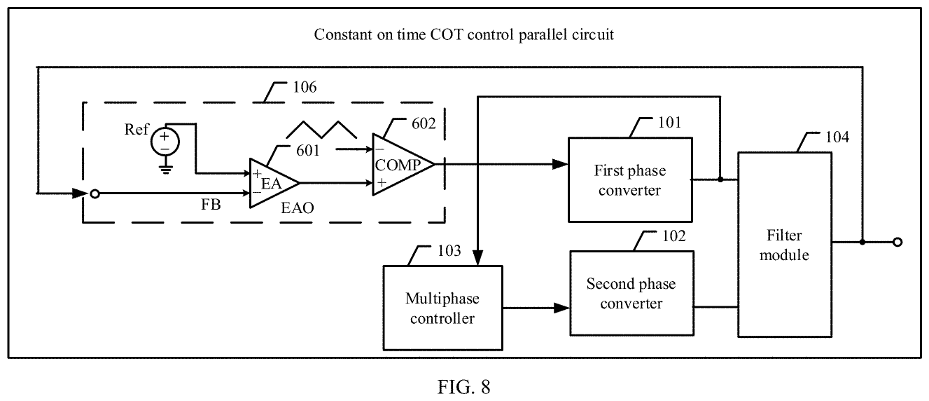

FIG. 8 is a schematic diagram of another structure of a COT parallel circuit according to this application.

As shown in FIG. 8, optionally, in this application, the signal processing module 106 includes a first operational amplifier 601 and a second comparator 602. A first reference signal is input to a first input terminal of the first operational amplifier 601. A second input terminal of the first operational amplifier 601 is electrically connected to the output terminal of the filter module 104. An output terminal of the first operational amplifier 601 is electrically connected to a first input terminal of the second comparator 602. The ramp compensation RAMP signal is input to a second input terminal of the second comparator 602. An output terminal of the second comparator 602 is electrically connected to the input terminal of the first phase converter 101.

In this application, the first operational amplifier may be configured to adjust, based on the first reference signal and the signal output by the filter module, a value of a signal output to the second comparator. The second comparator may output the first pulse signal when determining that a value of the RAMP signal is less than the value of the signal output by the first operational amplifier.

In this application, the first operational amplifier 601 is configured to adjust, by using a feedback, a frequency of a pulse signal output by the second comparator 602. The first reference signal is used to adjust a magnitude of a signal EAO. If a value of the first reference signal is greater than that of a power signal output by the filter module 104, the first operational amplifier 601 increases a value of the output signal EAO, and a frequency of the pulse signal output by the second comparator 602 is increased. Similarly, if the value of the first reference signal is less than that of the power signal output by the filter module 104, the first operational amplifier 601 reduces the value of the output signal EAO, and the frequency of the pulse signal output by the second comparator 602 is reduced. Further, the frequency of the pulse signal output by the second comparator 602 may be adjusted by adjusting a reference voltage, to further control the intensity of an output current of the entire COT parallel circuit.

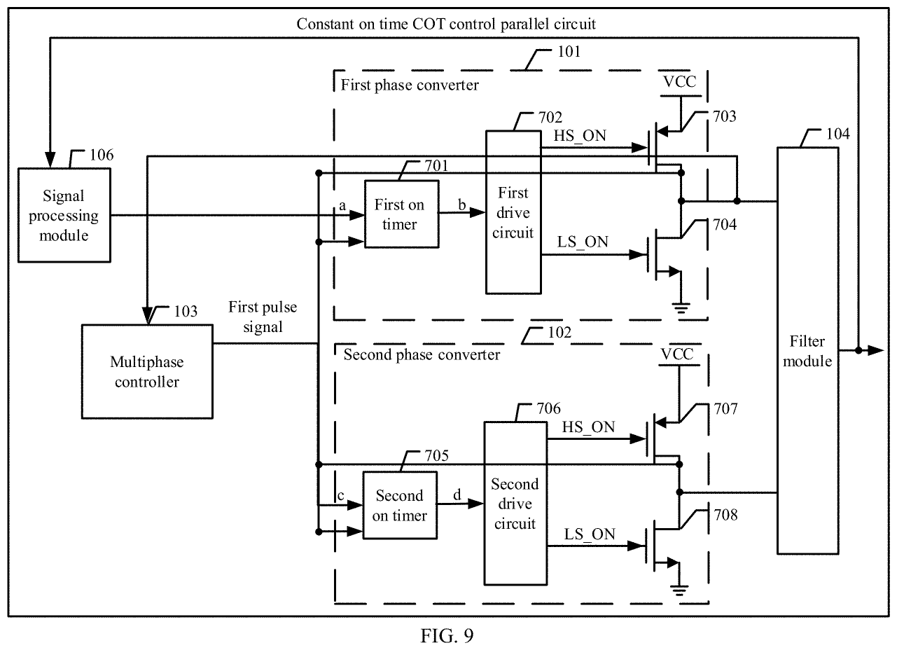

FIG. 9 is a schematic diagram of another structure of a COT parallel circuit according to this application.

As shown in FIG. 9, in this application, optionally, the first phase converter includes a first on timer 701, a first drive circuit 702, a sixth switch 703, and a seventh switch 704.

A first input terminal of the first on timer 701 is electrically connected to the output terminal of the signal processing module 106, a second input terminal of the first on timer 701 is electrically connected to a second input terminal of the second phase converter 102, and an output terminal of the first on timer 701 is electrically connected to an input terminal of the first drive circuit 702. A first output terminal of the first drive circuit 702 is electrically connected to a first terminal of the sixth switch 703, and a second output terminal of the first drive circuit 702 is electrically connected to a first terminal of the seventh switch 704. A second terminal of the sixth switch 703 is electrically connected to the external power supply, and a third terminal of the sixth switch 703 is electrically connected to the second input terminal of the first on timer 701, a second terminal of the seventh switch 704, and the first input terminal of the filter module 104. The second terminal of the seventh switch 704 is electrically connected to the first input terminal of the filter module 104, and a third terminal of the seventh switch 704 is grounded.

In this application, the first on timer 701 may output a first signal and a second signal based on signals output by the signal processing module 106 and the sixth switch 703. The first signal is used to indicate to the first drive circuit 702 to close the sixth switch 703 and open the seventh switch 704, and the external power supply in the first phase converter 101 outputs the first power signal through the sixth switch 703 in a closed state. The second signal is used to indicate to the first drive circuit 702 to close the seventh switch 704 and open the sixth switch 703, and the first phase converter 101 stops outputting the first power signal.

In this application, a structure of the second phase converter is similar to the structure of the first phase converter. For a specific implementation, refer to the structure shown in FIG. 9 for understanding. Details are not described herein again.

In this application, the signal processing module 106 outputs a pulse signal to the first on timer 701 based on the power signal output by the filter module 104 and the received RAMP signal. The first on timer 701 outputs a control signal b based on the pulse signal a and a current output by a VCC through the sixth switch 703. A high-level signal in the control signal b may to close the sixth switch 703, so that the external power supply VCC connected to the sixth switch 703 inputs a current to the filter module 104, that is, the first phase converter outputs the first power signal. A low-level signal in the control signal b may control the first drive circuit 702 to open the sixth switch 703 and close the seventh switch 704. The multiphase controller 103 receives the first power signal and outputs the first pulse signal to the second on timer 705. The second on timer 705 outputs a control signal d based on the pulse signal c and a current output by the VCC through the eighth switch 707. A high-level signal in the control signal d may control the second drive module 706 to close the eighth switch 707, so that the external power supply VCC connected to the eighth switch 707 inputs a current to the filter module 104, that is, the second phase converter outputs the second power signal. A low-level signal in the control signal d may control the second drive circuit 706 to open the eighth switch 707 and close the ninth switch 708.

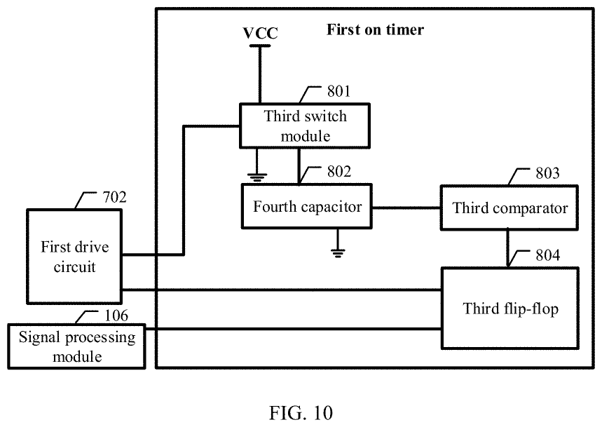

FIG. 10 is a schematic diagram of a structure of a first on timer according to this application.

As shown in FIG. 10, optionally, the first on timer may include a third switch module 801, a fourth capacitor 802, a third comparator 803, and a third flip-flop 804.

A first terminal of the third switch module 801 is electrically connected to the first drive circuit 702, a second terminal of the third switch module 801 is electrically connected to the external power supply, a third terminal of the third switch module is electrically connected to a first terminal of the fourth capacitor, and a fourth terminal of the third switch module is grounded. A second terminal of the fourth capacitor is electrically connected to a positive input terminal of the third comparator, and a third terminal of the fourth capacitor is grounded. An output terminal of the third comparator 803 is electrically connected to a first input terminal of the third flip-flop 804. A second input terminal of the third flip-flop 803 is electrically connected to the signal processing module 106, and an output terminal of the third flip-flop 804 is electrically connected to the first drive circuit 702.

In this application, the third switch module may control, based on a signal output by the first drive circuit, the external power supply to charge the fourth capacitor. When the signal output by the first drive circuit controls the sixth switch to be closed and controls the seventh switch to be open, a switch between the fourth capacitor and the ground cable in the third switch module is open. In this case, a switch between the external power supply and the fourth capacitor in the third switch module is closed, and the external power supply charges the fourth capacitor. When the signal output by the first drive circuit controls the sixth switch to be open and controls the seventh switch to be closed, the switch between the fourth capacitor and the ground cable in the third switch module is closed. In this case, the fourth capacitor empties charge, and a voltage of the fourth capacitor is zero.

In this application, a positive input terminal of the third comparator collects a voltage value of the fourth capacitor, and a reference signal is input to a negative input terminal of the third comparator. If the voltage value of the fourth capacitor during charging is greater than the reference signal input to the negative input terminal of the third comparator, the third comparator is inverted, and outputs a high-level signal (a fifth signal) to the third flip-flop. After the first input terminal of the third flip-flop receives a high-level signal (the second pulse signal) output by the signal processing module, the first signal is output, and the first drive circuit is controlled by the first signal to close the sixth switch and open the seventh switch. After the second input terminal of the third flip-flop receives a high-level signal, the second signal is output, and the first drive circuit opens the sixth switch and closes the seventh switch based on the second signal.

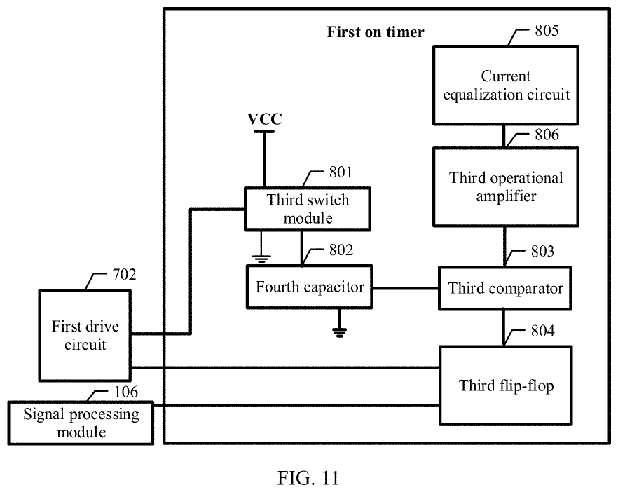

FIG. 11 is a schematic diagram of another structure of a first on timer according to this application.

As shown in FIG. 11, optionally, the first on timer may further include a current equalization circuit 805 and a third operational amplifier 806.

A first terminal of the current equalization circuit is electrically connected to the sixth switch and the second phase converter, and an output terminal of the current equalization circuit is electrically connected to a positive input terminal of the third operational amplifier. A negative input terminal of the third operational amplifier is electrically connected to the first phase converter.

In this application, the current equalization circuit may perform averaging on the first power signal and the second power signal that are output by the first phase converter and the second phase converter to obtain an average signal. After determining that the first power signal is less than the average signal, the third operational amplifier may reduce a value of a reference signal input to a second terminal of the third comparator. After determining that the first power signal is greater than the average signal, the third operational amplifier may increase the value of the reference signal input to the second terminal of the third comparator.

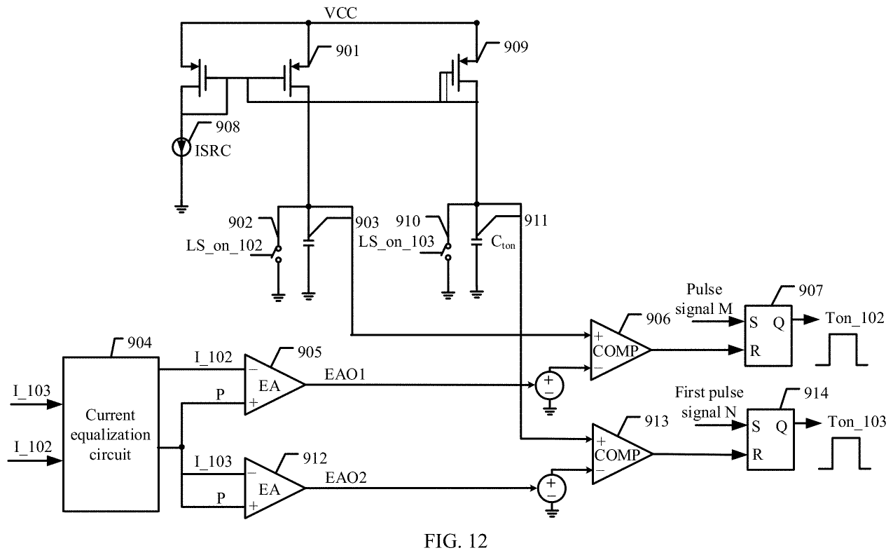

In this application, the first on timer and the second on timer have specific implementations. The following describes specific operating processes of the first on timer and the second on timer by using FIG. 12 as an example.

FIG. 12 is a schematic diagram of other structures of a first on timer and a second on timer according to this application.

As shown in FIG. 12, in this application, optionally, the first on timer 701 includes a switch 901, a switch 902, a capacitor 903, a current equalization circuit 904, an operational amplifier 905, a comparator 906, and a flip-flop 907. For ease of description, the third switch module 801 in FIG. 11 includes the switch 901 and the switch 902 in FIG. 12, the capacitor 903 in FIG. 12 is the fourth capacitor 802 in FIG. 11, the comparator 906 in FIG. 12 is the third comparator 803 in FIG. 11, the flip-flop 907 is the third flip-flop 804 in FIG. 11, the current equalization circuit 904 is the current equalization circuit 805 in FIG. 11, and the operational amplifier 905 is the third operational amplifier 806 in FIG. 11.

A first terminal of the switch 901 is electrically connected to a first terminal of a constant current source 908, a second terminal of the switch 901 is electrically connected to the external power supply VCC, and a third terminal of the switch 901 is electrically connected to a first terminal of the switch 902 and a first terminal of the capacitor 903. A first terminal of the switch 902 is electrically connected to the first terminal of the capacitor 903, a second terminal of the switch 902 is electrically connected to the first drive circuit 702, and a third terminal of the switch 902 is grounded. A second terminal of the capacitor 903 is grounded.

An input terminal of the current equalization circuit 904 is electrically connected to the sixth switch 703 and the second phase converter 102, and an output terminal of the current equalization circuit 904 is electrically connected to the operational amplifier 905.

An output terminal of the operational amplifier 905 is electrically connected to a negative input terminal of the comparator 906.

A positive input terminal of the comparator 906 is electrically connected to the first terminal of the capacitor 903 and the third terminal of the switch 901 through a sixth connection point, and an output terminal of the comparator 906 is electrically connected to a first input terminal of the flip-flop 907.

A second input terminal of the flip-flop 907 is electrically connected to the output terminal of the signal processing module 106, and an output terminal of the flip-flop 907 is electrically connected to the first drive circuit 702.

Optionally, the second on timer includes a switch 909, a switch 910, a capacitor 911, a current equalization circuit 905, an operational amplifier 912, a comparator 913, and a flip-flop 914.

A first terminal of the switch 909 is electrically connected to a first terminal of a constant current source 908, a second terminal of the switch 909 is electrically connected to the external power supply VCC, and a third terminal of the switch 909 is electrically connected to a first terminal of the switch 910 and a first terminal of the capacitor 911. A first terminal of the switch 910 is electrically connected to the first terminal of the capacitor 911, a second terminal of the switch 910 is electrically connected to the second drive circuit 706, and a third terminal of the switch 910 is grounded.

A second terminal of the capacitor 911 is grounded.

An input terminal of the current equalization circuit 904 is electrically connected to the eighth switch 707 and the first phase converter 101, and an output terminal of the current equalization circuit 904 is electrically connected to the operational amplifier 912.

An output terminal of the operational amplifier 912 is electrically connected to a negative input terminal of the comparator 913.

A positive input terminal of the comparator 913 is electrically connected to the first terminal of the capacitor 911 and the third terminal of the switch 609 through a seventh connection point, and an output terminal of the comparator 913 is electrically connected to a first input terminal of the flip-flop 914.

A second input terminal of the flip-flop 914 is electrically connected to the output terminal of the multiphase controller 103, and an output terminal of the flip-flop 914 is electrically connected to the second drive circuit 706.

In this application, the signal processing module 106 outputs a pulse signal M to the first on timer 701. In this case, the first on timer 701 receives the pulse signal M by using the second input terminal of the flip-flop 907, and the flip-flop 907 outputs a high-level signal, that is, a high-level part in a signal Ton_102. The high-level part may control the first drive circuit 702 to close the sixth switch 703 and open the seventh switch 704.

In this application, the constant current source 908 controls the switch 901 and the switch 909 to be closed, and the external power supply VCC charges the capacitor 903 and the capacitor 911 through the switch 901 and the switch 909. If the sixth switch 703 is in an open state and the seventh switch 704 is in a closed state, the switch 902 receives a control signal and is closed. In this case, voltages at both ends of the capacitor 903 are 0, and a voltage of the capacitor 903 that is collected by a positive electrode of the comparator 906 is 0. A value of a reference voltage collected by a negative electrode of the comparator 906 is greater than that of the voltage of the capacitor 903 that is collected by the positive electrode of the comparator 906, and the comparator 906 is not inverted. If the sixth switch 703 is in a closed state and the seventh switch 704 is in an open state, the switch 902 receives a control signal and is open, the switch 901 is closed, and the external power supply charges the capacitor 903. In this case, voltages at both ends of the capacitor 903 gradually increase. When a value of a reference voltage collected by the negative electrode of the comparator 906 is less than that of a voltage of the capacitor 903 that is collected by the positive electrode of the comparator 906, the comparator 906 is inverted, and the comparator 906 outputs a high-level signal to the first input terminal of the flip-flop 907. In this case, the output terminal of the flip-flop 907 outputs a low-level signal, that is, a low-level part in Ton_102 output by the output terminal. The low-level part may control the first drive circuit 702 to open the sixth switch 703 and close the seventh switch 704.

In this application, similarly, the multiphase controller 103 outputs a pulse signal N to the second on timer 705. In this case, the second on timer 705 receives the pulse signal N by using the second input terminal of the flip-flop 914, and the flip-flop 914 outputs a high-level signal, that is, a high-level part in a signal Ton_103. The high-level part may control the second drive circuit 706 to close the eighth switch 707 and open the ninth switch 708.

In this application, the constant current source 908 controls the switch 909 to be closed, and the external power supply VCC charges the capacitor 911 through the switch 909. If the eighth switch 707 is in an open state and the ninth switch 708 is in a closed state, the switch 610 receives a control signal and is closed. In this case, voltages at both ends of the seventh capacitor are 0, and a voltage of the capacitor 911 that is collected by a positive electrode of the comparator 913 is 0. A value of a reference voltage collected by a negative electrode of the comparator 913 is greater than that of the voltage of the capacitor 911 that is collected by the positive electrode of the comparator 913, and the comparator 913 is not inverted. If the eighth switch 707 is in a closed state and the ninth switch 708 is in an open state, the switch 910 receives a control signal and is open. In this case, voltages at both ends of the capacitor 911 gradually increase. When a value of a reference voltage collected by the negative electrode of the comparator 913 is less than that of a voltage of the capacitor 911 that is collected by the positive electrode of the comparator 913, the comparator 913 is inverted, and the comparator 913 outputs a high-level signal to an input terminal of the flip-flop 914. In this case, the output terminal of the flip-flop 914 outputs a low-level signal, that is, a low-level part in Ton_103 output by the output terminal. The low-level part may control the second drive circuit 706 to open the eighth switch 707 and close the ninth switch 708.

In this application, the current equalization circuit 904 collects a current I_102 at the sixth switch 703 in the first phase converter and a current I_103 at the eighth switch 707 in the second phase converter; and further, obtains, by using I_102 and I_103, an average current P obtained by performing averaging on output currents of the first phase converter and the second phase converter, and inputs the average current P to positive input terminals of the operational amplifier 905 and the operational amplifier 912. If the current I_102 input to a negative input terminal of the operational amplifier 905 is less than the average current P, the operational amplifier 906 increases a value of a reference voltage EAO1 input by the output terminal to the negative input terminal of the comparator 906. In this case, a larger voltage is required at the positive electrode of the comparator 906 so that the comparator 906 is inverted, a speed at which the comparator 906 is inverted is reduced, a time of outputting a high-level signal by the output terminal of the comparator 906 is extended, and the current I_102 at the sixth switch 703 is increased. Similarly, if the current I_102 input to the negative input terminal of the operational amplifier 905 is greater than the average current P, the operational amplifier 905 reduces a value of a reference voltage EAO2 input by the output terminal to the negative input terminal of the comparator 906. In this case, a smaller voltage may be input to the positive electrode of the comparator 906 so that the comparator 906 is inverted, a speed at which the comparator 906 is inverted is increased, a time of outputting a high-level signal by the output terminal of the comparator 906 is shortened, and the current I_102 at the sixth switch 703 is reduced. Similarly, a manner of adjusting the current I_103 at the eighth switch 707 by using the current equalization circuit 904, the operational amplifier 912, and the comparator 913 is similar to the foregoing manner of adjusting the current I_102 at the sixth switch 703. Details are not described herein again.

In this application, the current equalization circuit 904 has a specific implementation. The following embodiment describes in detail a possible implementation of the current equalization circuit 904.

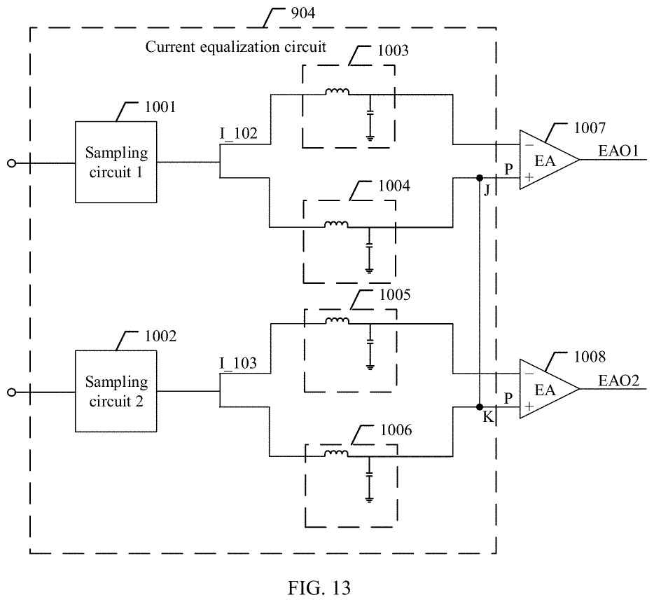

FIG. 13 is a schematic diagram of a structure of a current equalization circuit according to this application.

As shown in FIG. 13, in this application, the current equalization circuit 904 includes a first sampling circuit 1001, a second sampling circuit 1002, a filter 1003, a filter 1004, a filter 1005, and a filter 1006. The filter 1004 and the filter 1006 have a common node.

Similarly, for ease of description, an operational amplifier 1007 in FIG. 13, the operational amplifier 905 in FIG. 12, and the operational amplifier 806 in FIG. 11 are a same amplifier.

Optionally, the filter 1003 to the filter 1006 may be RC filters, or may be other filters. This is not specifically limited herein. In FIG. 13, only an RC filter is used as an example for description.

An input terminal of the first sampling circuit 1001 is electrically connected to the sixth switch 703, a first output terminal of the first sampling circuit 1001 is electrically connected to an input terminal of the filter 1003, and a second output terminal of the first sampling circuit 1001 is electrically connected to an input terminal of the filter 1004.

An output terminal of the filter 1003 is electrically connected to a negative input terminal of the operational amplifier 1007.

An output terminal of the filter 1004 is electrically connected to a positive input terminal of the operational amplifier 1007 and a positive input terminal of an operational amplifier 1008.

An input terminal of the second sampling circuit 1002 is electrically connected to the eighth switch 307, a first output terminal of the second sampling circuit 1002 is electrically connected to an input terminal of the filter 1005, and a second output terminal of the second sampling circuit 1002 is electrically connected to an input terminal of the filter 1006.

An output terminal of the filter 1005 is electrically connected to a negative input terminal of the operational amplifier 1008.

An output terminal of the filter 1006 is electrically connected to a positive input terminal of the operational amplifier 1007 and a positive input terminal of an operational amplifier 1008.

In this application, the first sampling circuit 1001 collects the current I_102 at the sixth switch, the first sampling circuit outputs the current I_102, and the filter 1003 filters the current I_102 and then inputs a filtered current to the negative input terminal of the operational amplifier 1007. The second sampling circuit collects the current I_103 at the eighth switch 307, the second sampling circuit 1002 outputs the current I_103, and the filter 1005 filters the current I_103 and then inputs a filtered current to the negative input terminal of the operational amplifier 1008. The first sampling circuit 1001 outputs the current I_102 to the filter 1004, and the filter 1004 filters the current I_102. Because the output terminal of the filter 1004 is electrically connected to the output terminal of the filter 1006, the current output by the filter 1004 and the current output by the filter 1006 are equalized at a point J and a point K. To be specific, an electrical signal P output to the operational amplifier 1007 and the operational amplifier 1008 at the point J and the point K is an electrical signal P (an average current signal) obtained by performing averaging on the current I_102 and the current I_103. If a value of the current I_102 input to the negative input terminal of the operational amplifier 1007 is less than a value of the electrical signal P, the operational amplifier 1007 increases a value of an output electrical signal EAO1. On the contrary, if the value of the current I_102 input to the negative input terminal of the operational amplifier 1007 is greater than the value of the electrical signal P, the operational amplifier 1007 reduces the value of the output electrical signal EAO1. Similarly, if a value of the current I_103 input to the negative input terminal of the operational amplifier 1008 is less than a value of the electrical signal P, the operational amplifier 1008 increases a value of an output electrical signal EAO2. On the contrary, if the value of the current I_103 input to the negative input terminal of the operational amplifier 1008 is greater than the value of the electrical signal P, the operational amplifier 1008 reduces the value of the output electrical signal EAO2.

In this application, the filter module included in the COT parallel circuit has a specific implementation. The specific implementation is described in the following embodiment.

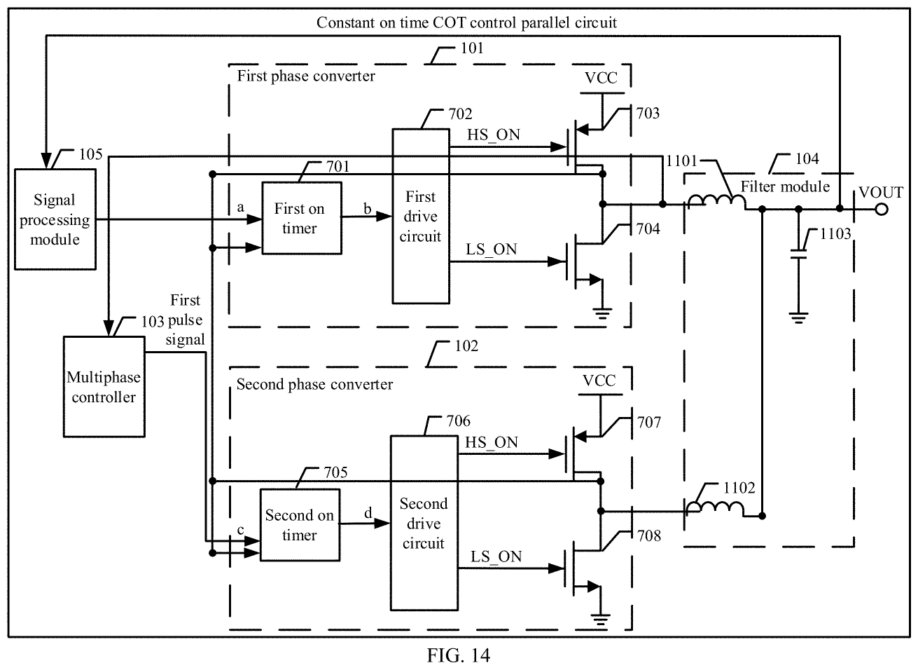

FIG. 14 is a schematic diagram of a structure of a COT multiphase parallel circuit according to this application.

As shown in FIG. 14, in this application, optionally, the filter module 104 may include a first inductor 1101, a second inductor 1102, and a third capacitor 1103.

A first terminal of the first inductor 1101 is electrically connected to the third terminal of the sixth switch 703 and the second terminal of the seventh switch 704, and a second terminal of the first inductor 1101 is electrically connected to a first terminal of the second inductor 1102 and a first terminal of the third capacitor 1103.

A first terminal of the second inductor 1102 is electrically connected to a third terminal of the eighth switch 707 and a fourth terminal of the ninth switch 708, and a second terminal of the second inductor 1102 is electrically connected to a first terminal of the third capacitor 1103.

A second terminal of the third capacitor 1103 is grounded.

In this application, if the sixth switch 703 is closed, the external power supply VCC may charge the first inductor 1101 through the sixth switch 703. If the sixth switch 703 is open and the seventh switch 704 is closed, the first inductor 1101 discharges to the output terminal of the filter module 104 and the seventh switch 704, and the third capacitor 1103 filters a current output by the first inductor 1101, so that the filter module 104 can output a stable ripple-free power signal. Similarly, if the eighth switch 707 is closed, the external power supply VCC may charge the second inductor 1102 through the eighth switch 707. If the eighth switch 707 is open and the ninth switch 708 is closed, the second inductor 1102 discharges to the output terminal of the filter module 104 and the ninth switch 708, and the third capacitor 1103 filters a current output by the second inductor 1102, so that the filter module 104 can output a stable ripple-free power signal.

In this application, optionally, if the COT parallel circuit includes more phase converters, the filter module 104 may include more inductors, and a connection manner and an operating manner of the other more inductors are similar to those of the second inductor 1102 described in the embodiment of FIG. 13. Details are not described herein.

In this application, the COT parallel circuit provided in the foregoing embodiments may be applied to other products in addition to the power supply device, for example, a vehicle-mounted power supply, a base station power supply, or another product related to direct current-to-direct current switching control.

The foregoing descriptions are merely specific implementations of embodiments of this application, but are not intended to limit the protection scope of embodiments of this application.

The foregoing describes in detail the COT parallel circuit and the power supply device provided in embodiments of this application. Specific examples are used in this specification to describe the principles and embodiments of this application. The descriptions of the foregoing embodiments are merely intended to help understand the method of this application and the core ideas thereof. In addition, a person of ordinary skill in the art may make variations and modifications to this application in terms of the specific implementations and application scopes based on the ideas of this application. Therefore, the content of this specification shall not be construed as a limitation to this application.

What is claimed is:

1. A constant on time COT control parallel circuit, comprising:
a first phase converter, a second phase converter, a multiphase controller, and a filter module, wherein
an output terminal of the first phase converter is electrically connected to an input terminal of the multiphase controller and a first input terminal of the filter module;
an input terminal of the second phase converter is electrically connected to an output terminal of the multiphase controller, and an output terminal of the second phase converter is electrically connected to a second input terminal of the filter module; and
the multiphase controller is configured to control, in one period of a RAMP signal received by the COT parallel circuit and based on a first power signal output by the first phase converter, the second phase converter to output a second power signal.

2. The COT parallel circuit according to claim 1, wherein the multiphase controller comprises a frequency divider, a first phase inverter, a first period control module, a second period control module, and a first OR gate, wherein
an input terminal of the frequency divider is electrically connected to the output terminal of the first phase converter, and an output terminal of the frequency divider is electrically connected to an input terminal of the first period control module and an input terminal of the first phase inverter through a first connection point;
an output terminal of the first phase inverter is electrically connected to an input terminal of the second period control module;
an input terminal of the first OR gate is electrically connected to an output terminal of the first period control module and an output terminal of the second period control module;
the first period control module and the second period control module are configured to: collect, by using a time collection circuit comprising a plurality of capacitors and a plurality of constant current sources, an output period of the first power signal output by the first phase converter, and output a target signal based on the output period; and
the first OR gate is configured to output a first pulse signal based on the target signal output by the first period control module or the second period control module, wherein the first pulse signal is used to indicate to the second phase converter to output the second power signal.

3. The COT parallel circuit according to claim 2, wherein the first period control module comprises a second phase inverter, a constant current source module, a first switch module, a second switch module, a capacitor module, and a first comparator, and the capacitor module comprises a first capacitor and a second capacitor;
a first terminal of the second phase inverter is electrically connected to the output terminal of the frequency divider, and a second terminal of the second phase inverter is electrically connected to a first terminal of the second switch module;
a first terminal of the first switch module is electrically connected to the output terminal of the frequency divider, a second terminal of the first switch module is electrically connected to a first terminal of the constant current source module, and a third terminal of the first switch module is electrically connected to a first terminal of the capacitor module;
a second terminal of the second switch module is electrically connected to a second terminal of the constant current source module, and a third terminal of the second switch module is grounded;
a third terminal of the capacitor module is grounded;
a negative input terminal of the first comparator is electrically connected to the first switch module and the first capacitor through a second connection point, and a positive input terminal of the first comparator is electrically connected to the first switch module and the second capacitor through a third connection point;
the first switch module is configured to control, based on different signals output by the frequency divider, a charging time of the first capacitor and the second capacitor in the capacitor module by the constant current source module, wherein the charging time of the first capacitor and the second capacitor in the capacitor module by the constant current source module is the same as the output period of the first power signal;
the second switch module is configured to control, based on a signal output by the second phase inverter, the first capacitor to discharge; and
the first comparator is configured to: when the first capacitor discharges, output the target signal when determining that a voltage value of the first capacitor is less than a voltage value of the second capacitor.

4. The COT parallel circuit according to claim 3, wherein the first period control module further comprises a first flip-flop;
a first input terminal of the first flip-flop is electrically connected to the first comparator, a second input terminal of the first flip-flop is electrically connected to the frequency divider, and an output terminal of the first flip-flop is electrically connected to the second switch module;
the first flip-flop is configured to control, based on electrical signals output by the first comparator and the frequency divider, some switches in the second switch module to be closed; and
the second switch module is further configured to control, by closing some switches and based on a signal output by the first flip-flop, the first capacitor and the second capacitor to empty charges.

5. The COT parallel circuit according to claim 4, wherein the constant current source module comprises a first constant current source, a second constant current source, and a third constant current source, the first switch module comprises n and a second switch, and the second switch module comprises a third switch, a fourth switch, and a fifth switch;
first terminals of the first switch and the second switch are electrically connected to the output terminal of the frequency divider, a second terminal of the first switch is electrically connected to a first terminal of the first constant current source, a third terminal of the first switch is electrically connected to a first terminal of the first capacitor, a second terminal of the second switch is electrically connected to a first terminal of the second constant current source, and a third terminal of the second switch is electrically connected to a first terminal of the second capacitor;
a first terminal of the third switch is electrically connected to the second phase inverter, a second terminal of the third switch is electrically connected to the third constant current source, a third terminal of the third switch is grounded, a first terminal of the fourth switch is electrically connected to the first terminal of the first capacitor and the third terminal of the first switch through a fourth connection point, a second terminal of the fourth switch is electrically connected to the output terminal of the first flip-flop, a third terminal of the fourth switch is grounded, a first terminal of the fifth switch is electrically connected to the first terminal of the second capacitor and the third terminal of the second switch through a fifth connection point, a second terminal of the fifth switch is electrically connected to the output terminal of the first flip-flop, and a third terminal of the fifth switch is grounded; and
second terminals of the first constant current source and the second constant current source are electrically connected to an external power supply.

6. The COT parallel circuit according to claim 1, wherein the COT parallel circuit further comprises a signal processing module;
an input terminal of the signal processing module is electrically connected to an output terminal of the filter module, and an output terminal of the signal processing module is electrically connected to an input terminal of the first phase converter; and
the signal processing module is configured to output a second pulse signal based on the received RAMP signal and a signal output by the filter module, wherein the second pulse signal is used to indicate to the first phase converter to output the first power signal.

7. The COT parallel circuit according to claim 6, wherein the signal processing module comprises a first operational amplifier and a second comparator;
a first reference signal is input to a first input terminal of the first operational amplifier, a second input terminal of the first operational amplifier is electrically connected to the output terminal of the filter module, and an output terminal of the first operational amplifier is electrically connected to a first input terminal of the second comparator;
the ramp compensation RAMP signal is input to a second input terminal of the second comparator, and an output terminal of the second comparator is electrically connected to the input terminal of the first phase converter;
the first operational amplifier is configured to adjust, based on the first reference signal and the signal output by the filter module, a value of a signal output to the second comparator; and
the second comparator is configured to output the first pulse signal when determining that a value of the RAMP signal is less than the value of the signal output by the first operational amplifier.

8. The COT parallel circuit according to claim 1, wherein the first phase converter comprises a first on timer, a first drive circuit, a sixth switch, and a seventh switch;
a first input terminal of the first on timer is electrically connected to the output terminal of the signal processing module, a second input terminal of the first on timer is electrically connected to a second input terminal of the second phase converter, and an output terminal of the first on timer is electrically connected to an input terminal of the first drive circuit;
a first output terminal of the first drive circuit is electrically connected to a first terminal of the sixth switch, and a second output terminal of the first drive circuit is electrically connected to a first terminal of the seventh switch;
a second terminal of the sixth switch is electrically connected to the external power supply, and a third terminal of the sixth switch is electrically connected to the second input terminal of the first on timer, a second terminal of the seventh switch, and the first input terminal of the filter module;
the second terminal of the seventh switch is electrically connected to the first input terminal of the filter module, and a third terminal of the seventh switch is grounded; and
the first on timer is configured to output a first signal and a second signal based on the second pulse signal output by the signal processing module and a signal output by the sixth switch, wherein the first signal is used to indicate to the first drive circuit to close the sixth switch and open the seventh switch, the external power supply in the first phase converter outputs the first power signal through the sixth switch in a closed state, the second signal is used to indicate to the first drive circuit to close the seventh switch and open the sixth switch, and the first phase converter stops outputting the first power signal.

9. The COT parallel circuit according to claim 1, wherein the second phase converter comprises a second on timer, a second drive circuit, an eighth switch, and a ninth switch;
a first input terminal of the second on timer is electrically connected to the output terminal of the multiphase controller, a second input terminal of the second on timer is electrically connected to a second input terminal of the first phase converter, and an output terminal of the second on timer is electrically connected to an input terminal of the second drive circuit;
a first output terminal of the second drive circuit is electrically connected to a first terminal of the eighth switch, and a second output terminal of the second drive circuit is electrically connected to a first terminal of the ninth switch;
a second terminal of the eighth switch is electrically connected to the external power supply, a third terminal of the eighth switch is electrically connected to the second input terminal of the second on timer, a second terminal of the ninth switch, and the second input terminal of the filter module;
the second terminal of the ninth switch is electrically connected to the second input terminal of the filter module, and a third terminal of the ninth switch is grounded; and
the second conduction delay timing circuit is configured to output a third signal and a fourth signal based on the first pulse signal output by the multiphase controller and a signal output by the eighth switch, wherein the third signal is used to indicate to the second drive circuit to close the eighth switch and open the ninth switch, the external power supply in the second phase converter outputs the second power signal through the eighth switch in a closed state, the fourth signal is used to indicate to the second drive circuit to close the ninth switch and open the eighth switch, and the second phase converter stops outputting the second power signal.

10. The COT parallel circuit according to claim 8, wherein the first on timer comprises a third switch module, a fourth capacitor, a third comparator, and a third flip-flop;
a first terminal of the third switch module is electrically connected to the first drive circuit, a second terminal of the third switch module is electrically connected to the external power supply, a third terminal of the third switch module is electrically connected to a first terminal of the fourth capacitor, and a fourth terminal of the third switch module is grounded;
a second terminal of the fourth capacitor is electrically connected to a positive input terminal of the third comparator, and a third terminal of the fourth capacitor is grounded;
an output terminal of the third comparator is electrically connected to a first input terminal of the third flip-flop;
a second input terminal of the third flip-flop is electrically connected to the signal processing module, and an output terminal of the third flip-flop is electrically connected to the first drive circuit;
the third switch module is configured to control, based on a signal output by the first drive circuit, the external power supply to charge the fourth capacitor;
the third comparator is configured to output a fifth signal when determining that a value of a reference signal received by a second input terminal of the third comparator is less than a voltage value of the fourth capacitor; and
the third flip-flop is configured to: output the first signal based on a pulse signal output by the signal processing module, and output the second signal based on the fifth signal.

11. The COT parallel circuit according to claim 9, wherein the first on timer comprises a third switch module, a fourth capacitor, a third comparator, and a third flip-flop;
a first terminal of the third switch module is electrically connected to the first drive circuit, a second terminal of the third switch module is electrically connected to the external power supply, a third terminal of the third switch module is electrically connected to a first terminal of the fourth capacitor, and a fourth terminal of the third switch module is grounded;
a second terminal of the fourth capacitor is electrically connected to a positive input terminal of the third comparator, and a third terminal of the fourth capacitor is grounded;
an output terminal of the third comparator is electrically connected to a first input terminal of the third flip-flop;
a second input terminal of the third flip-flop is electrically connected to the signal processing module, and an output terminal of the third flip-flop is electrically connected to the first drive circuit;
the third switch module is configured to control, based on a signal output by the first drive circuit, the external power supply to charge the fourth capacitor;
the third comparator is configured to output a fifth signal when determining that a value of a reference signal received by a second input terminal of the third comparator is less than a voltage value of the fourth capacitor; and
the third flip-flop is configured to: output the first signal based on a pulse signal output by the signal processing module, and output the second signal based on the fifth signal.

12. The COT parallel circuit according to claim 10, wherein the first on timer further comprises a current equalization circuit and a third operational amplifier, the current equalization circuit comprises a plurality of RC filters, and there is a common node between some RC filters;
a first terminal of the current equalization circuit is electrically connected to the sixth switch and the second phase converter, and an output terminal of the current equalization circuit is electrically connected to the third operational amplifier;
the current equalization circuit is configured to: perform averaging on the first power signal and the second power signal that are output by the first phase converter and the second phase converter to obtain an average signal, input a filtered first power signal to a positive input terminal of the third operational amplifier, and input the average signal to a negative input terminal of the third operational amplifier; and
the third operational amplifier is configured to: after determining that the filtered first power signal is less than the average signal, reduce a value of a reference signal input to a second terminal of the third comparator; or after determining that the first power signal is greater than the average signal, increase the value of the reference signal input to the second terminal of the third comparator.

13. The COT parallel circuit according to claim 11, wherein the first on timer further comprises a current equalization circuit and a third operational amplifier, the current equalization circuit comprises a plurality of RC filters, and there is a common node between some RC filters;
a first terminal of the current equalization circuit is electrically connected to the sixth switch and the second phase converter, and an output terminal of the current equalization circuit is electrically connected to the third operational amplifier;
the current equalization circuit is configured to: perform averaging on the first power signal and the second power signal that are output by the first phase converter and the second phase converter to obtain an average signal, input a filtered first power signal to a positive input terminal of the third operational amplifier, and input the average signal to a negative input terminal of the third operational amplifier; and
the third operational amplifier is configured to: after determining that the filtered first power signal is less than the average signal, reduce a value of a reference signal input to a second terminal of the third comparator; or after determining that the first power signal is greater than the average signal, increase the value of the reference signal input to the second terminal of the third comparator.

14. The COT parallel circuit according to claim 1, wherein the filter module comprises a first inductor, a second inductor, and a third capacitor;
a first terminal of the first inductor is electrically connected to the third terminal of the sixth switch and the second terminal of the seventh switch, and a second terminal of the first inductor is electrically connected to a first terminal of the second inductor and a first terminal of the third capacitor;
the first terminal of the second inductor is electrically connected to the third terminal of the eighth switch and the second terminal of the ninth switch, and a second terminal of the second inductor is electrically connected to the first terminal of the third capacitor;
a second terminal of the third capacitor is grounded; and
the first inductor, the second inductor, and the third capacitor are jointly configured to filter output ripples of the first power signal and the second power signal.

15. A power supply device, comprising:
a controller and a constant on time COT control parallel circuit, wherein
the COT control parallel circuit comprises a first phase converter, a second phase converter, a multiphase controller, and a filter module;
an output terminal of the first phase converter is electrically connected to an input terminal of the multiphase controller and a first input terminal of the filter module;
an input terminal of the second phase converter is electrically connected to an output terminal of the multiphase controller, and an output terminal of the second phase converter is electrically connected to a second input terminal of the filter module; and
the multiphase controller is configured to control, in one period of a RAMP signal received by the COT parallel circuit and based on a first power signal output by the first phase converter, the second phase converter to output a second power signal.

16. The power supply device according to claim 15, wherein the multiphase controller comprises a frequency divider, a first phase inverter, a first period control module, a second period control module, and a first OR gate, wherein
an input terminal of the frequency divider is electrically connected to the output terminal of the first phase converter, and an output terminal of the frequency divider is electrically connected to an input terminal of the first period control module and an input terminal of the first phase inverter through a first connection point;
an output terminal of the first phase inverter is electrically connected to an input terminal of the second period control module;
an input terminal of the first OR gate is electrically connected to an output terminal of the first period control module and an output terminal of the second period control module;
the first period control module and the second period control module are configured to: collect, by using a time collection circuit comprising a plurality of capacitors and a plurality of constant current sources, an output period of the first power signal output by the first phase converter, and output a target signal based on the output period; and
the first OR gate is configured to output a first pulse signal based on the target signal output by the first period control module or the second period control module, wherein the first pulse signal is used to indicate to the second phase converter to output the second power signal.

17. The power supply device according to claim 16, wherein the first period control module comprises a second phase inverter, a constant current source module, a first switch module, a second switch module, a capacitor module, and a first comparator, and the capacitor module comprises a first capacitor and a second capacitor;
a first terminal of the second phase inverter is electrically connected to the output terminal of the frequency divider, and a second terminal of the second phase inverter is electrically connected to a first terminal of the second switch module;
a first terminal of the first switch module is electrically connected to the output terminal of the frequency divider, a second terminal of the first switch module is electrically connected to a first terminal of the constant current source module, and a third terminal of the first switch module is electrically connected to a first terminal of the capacitor module;
a second terminal of the second switch module is electrically connected to a second terminal of the constant current source module, and a third terminal of the second switch module is grounded;
a third terminal of the capacitor module is grounded;
a negative input terminal of the first comparator is electrically connected to the first switch module and the first capacitor through a second connection point, and a positive input terminal of the first comparator is electrically connected to the first switch module and the second capacitor through a third connection point;
the first switch module is configured to control, based on different signals output by the frequency divider, a charging time of the first capacitor and the second capacitor in the capacitor module by the constant current source module, wherein the charging time of the first capacitor and the second capacitor in the capacitor module by the constant current source module is the same as the output period of the first power signal;
the second switch module is configured to control, based on a signal output by the second phase inverter, the first capacitor to discharge; and
the first comparator is configured to: when the first capacitor discharges, output the target signal when determining that a voltage value of the first capacitor is less than a voltage value of the second capacitor.

18. The COT parallel circuit according to claim 15, wherein the COT parallel circuit further comprises a signal processing module;
an input terminal of the signal processing module is electrically connected to an output terminal of the filter module, and an output terminal of the signal processing module is electrically connected to an input terminal of the first phase converter; and
the signal processing module is configured to output a second pulse signal based on the received RAMP signal and a signal output by the filter module, wherein the second pulse signal is used to indicate to the first phase converter to output the first power signal.

19. The COT parallel circuit according to claim 18, wherein the signal processing module comprises a first operational amplifier and a second comparator;
a first reference signal is input to a first input terminal of the first operational amplifier, a second input terminal of the first operational amplifier is electrically connected to the output terminal of the filter module, and an output terminal of the first operational amplifier is electrically connected to a first input terminal of the second comparator;
the ramp compensation RAMP signal is input to a second input terminal of the second comparator, and an output terminal of the second comparator is electrically connected to the input terminal of the first phase converter;
the first operational amplifier is configured to adjust, based on the first reference signal and the signal output by the filter module, a value of a signal output to the second comparator; and
the second comparator is configured to output the first pulse signal when determining that a value of the RAMP signal is less than the value of the signal output by the first operational amplifier.

20. The COT parallel circuit according to claim 15, wherein the first phase converter comprises a first on timer, a first drive circuit, a sixth switch, and a seventh switch;
a first input terminal of the first on timer is electrically connected to the output terminal of the signal processing module, a second input terminal of the first on timer is electrically connected to a second input terminal of the second phase converter, and an output terminal of the first on timer is electrically connected to an input terminal of the first drive circuit;
a first output terminal of the first drive circuit is electrically connected to a first terminal of the sixth switch, and a second output terminal of the first drive circuit is electrically connected to a first terminal of the seventh switch;
a second terminal of the sixth switch is electrically connected to the external power supply, and a third terminal of the sixth switch is electrically connected to the second input terminal of the first on timer, a second terminal of the seventh switch, and the first input terminal of the filter module;
the second terminal of the seventh switch is electrically connected to the first input terminal of the filter module, and a third terminal of the seventh switch is grounded; and
the first on timer is configured to output a first signal and a second signal based on the second pulse signal output by the signal processing module and a signal output by the sixth switch, wherein the first signal is used to indicate to the first drive circuit to close the sixth switch and open the seventh switch, the external power supply in the first phase converter outputs the first power signal through the sixth switch in a closed state, the second signal is used to indicate to the first drive circuit to close the seventh switch and open the sixth switch, and the first phase converter stops outputting the first power signal.
